(19) United States
(12) Patent Application Publication
(10) Pub. No.: US 2026/0181501 A1
(43) Pub. Date: Jun. 25, 2026

(54) ON CLI MITIGATION TECHNIQUES FOR LTM IN FD SYSTEMS

(71) Applicant: InterDigital Patent Holdings, Inc., Wilmington, DE (US)

(72) Inventors: Nazli Khan Beigi, Longueuil (CA); Jonghyun Park, Syosset, NY (US); Moon IL Lee, Melville, NY (US); Paul Marinier, Brossard (CA); Aata El Hamss, Laval (CA); Virgile Garcia, Antibes (FR)

(73) Assignee: InterDigital Patent Holdings, Inc., Wilmington, DE (US)

(21) Appl. No.: 18/990,046

(22) Filed: Dec. 20, 2024

(51) Int. Cl. H04W 36/08; H04W 36/00

(52) U.S. Cl. CPC H04W 36/08; H04W 36/0058

(57) ABSTRACT

Methods for triggered mobility event evaluation, in the presence of cross-link interference (CLI), are disclosed. A wireless transmit/receive unit (WTRU) may communicate, with a base station in a serving cell, using downlink subbands of a first frequency band and an uplink subband of the first frequency band in full duplex slots, wherein the downlink subbands and the uplink subband are non-overlapping. The WTRU may measure a signal strength of a signal received on the uplink subband in a first full duplex slot. The WTRU may select a set of reference signal received power (RSRP) threshold values from among a plurality of sets of RSRP threshold values by comparing the measured signal strength to at least one threshold. The WTRU may evaluate one or more mobility measurement events using the selected set of RSRP threshold values to trigger and perform cell switching, cell selection, or cell reselection.

### BACKGROUND

New Radio (NR) duplex operation may provide a foundation in improving conventional time division duplexing (TDD) operation by enhancing UL coverage, improving capacity, reducing latency. The conventional TDD is based on splitting the time domain between the uplink and downlink. Full duplex, or more specifically, sub-band non-overlapping full duplex (SBFD) at the gNB within a conventional TDD band, may be used.

### SUMMARY

Methods for triggered mobility event evaluation, in the presence of wireless transmit/receive unit (WTRU)-to-WTRU cross-link interference (CLI), are disclosed. A WTRU may communicate, with a first base station in a serving cell, using downlink subbands of a first frequency band and an uplink subband of the first frequency band in full duplex slots, wherein the downlink subbands and the uplink subband are non-overlapping. The WTRU may measure a signal strength of a signal received on the uplink subband in a first full duplex slot. The WTRU may select a set of reference signal received power (RSRP) threshold values from among a plurality of sets of RSRP threshold values by comparing the measured signal strength to at least one threshold. The WTRU may evaluate one or more mobility measurement events using the selected set of RSRP threshold values to trigger cell switching, cell selection, or cell reselection. The WTRU may perform the triggered cell switching, cell selection, or cell reselection.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a frame format diagram illustrating an example TDD framework 200 with SBFD configuration;

FIG. 3 is a system diagram illustrating an example radio access network (RAN) illustrating an example scenario of WTRU-to-WTRU cross-link interference (CLI) in layer 1/layer 2 (L1/L2) Triggered Mobility (LTM) systems;

FIG. 4 is flow diagram illustrating an example LTM events evaluation procedure in the presence of WTRU-to-WTRU CLI, that may be performed by a WTRU; and

FIG. 5 is flow diagram illustrating an example detailed LTM event evaluation procedure in the presence of WTRU-to-WTRU CLI, that may be performed by a WTRU.

### DETAILED DESCRIPTION

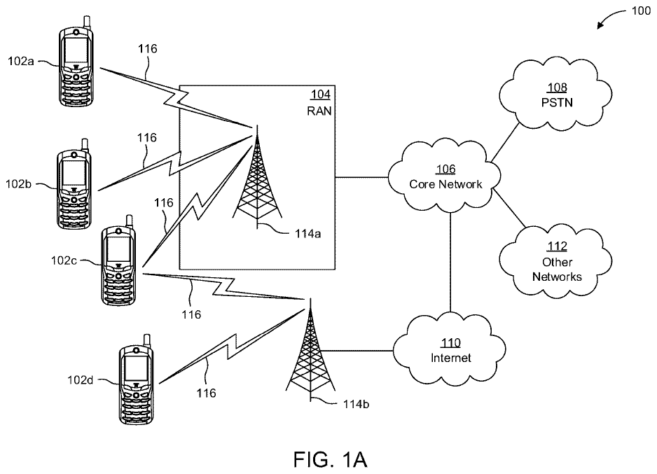

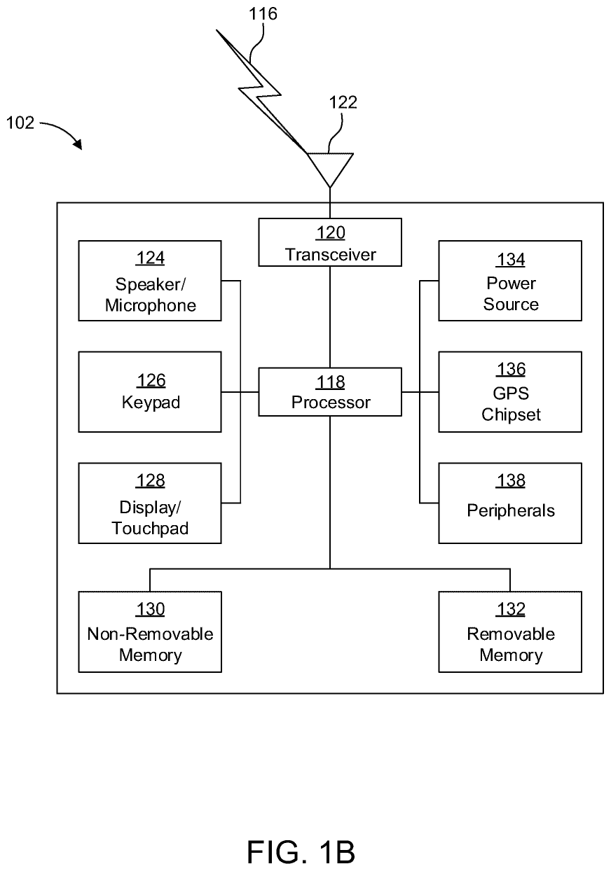

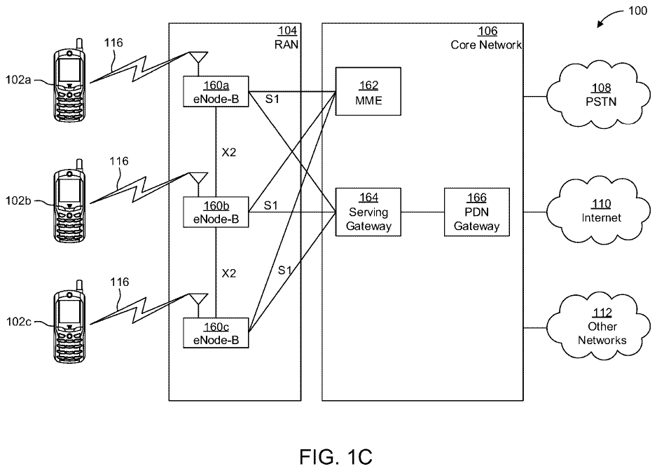

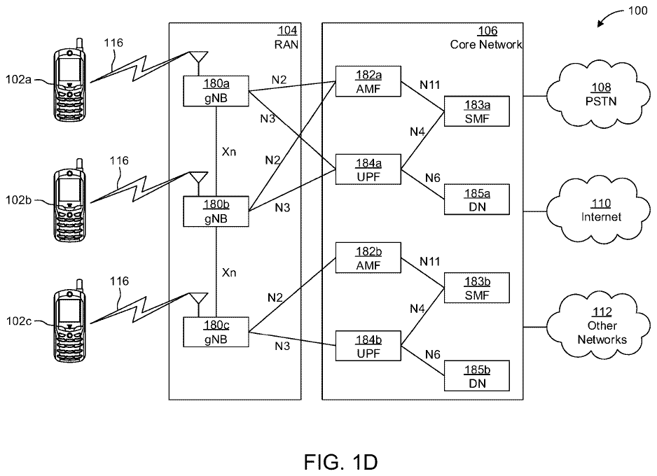

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHZ, 40 MHZ, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHZ. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’. A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a reference signal (RS) (such as Channel State Information-Reference Signal (CSI-RS) CSI-RS) or a SS block. The WTRU transmission may be referred to as “target”, and the received RS or synchronization signal (SS) block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) signaling or signaled by MAC CE or downlink control information (DCI). For example, a WTRU may implicitly transmit signals on physical uplink shared channel (PUSCH) and Demodulation Reference Signal (DM-RS) of PUSCH according to the same spatial domain filter as a sounding reference signal (SRS) indicated by an SRS resource indicator (SRI) indicated in downlink control information (DCI) or configured by RRC signaling. In another example, a spatial relation may be configured by RRC for an SRI or signaled by MAC CE for a physical uplink control channel (PUCCH). Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as physical downlink control channel (PDCCH) or physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

Herein, a transmission and reception point (TRP) may be interchangeably used with one or more of transmission point (TP), reception point (RP), radio remote head (RRH), distributed antenna (DA), base station (BS), a sector (of a BS), and a cell (e.g., a geographical cell area served by a BS), but still consistent with example embodiments and solutions disclosed herein. Herein, Multi-TRP may be interchangeably used with one or more of MTRP, M-TRP, and multiple TRPs, but still consistent with this example embodiments and solutions disclosed herein. Herein, the term “subband” and/or “sub-band” is used to refer to a frequency-domain resource and may be characterized by at least one of the following: a set of resource blocks (RBs); a set of resource block (RB) sets (e.g. when a carrier has intra-cell guard bands); a set of interlaced resource blocks; a bandwidth part (BWP), or portion thereof; and/or a carrier, or portion thereof. For example, a subband may be characterized by a starting RB and a number of RBs for a set of contiguous RBs within a bandwidth part. A subband may also be defined by the value of a frequency-domain resource allocation field and bandwidth part index.

Herein, the term “XDD” is used to refer to a subband-wise duplex (e.g., either UL or DL being used per subband) and may be characterized by at least one of the following: cross Division Duplex (e.g., subband-wise Frequency Division Duplexing (FDD) within a TDD band); subband non-overlapping full duplex (SBFD); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a full duplex other than a same-frequency (e.g., spectrum sharing, subband-wise-overlapped) full duplex; and/or an advanced duplex method (e.g., other than pure TDD or FDD).

Herein, the term “dynamic (or flexible) TDD” is used to refer to a TDD system/cell that may dynamically (and/or flexibly) change/adjust/switch a communication direction (e.g., a downlink, an uplink, or a sidelink, etc.) on a time instance (e.g., slot, symbol, subframe, and/or the like). In an example, in a system employing dynamic/flexible TDD, a component carrier (CC) or a bandwidth part (BWP) may have one single type among ‘D’ (downlink), ‘U’ (uplink), and ‘F’ (flexible) on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-layer interference (CLI).

A WTRU may be operating during at least one of the one or more RRC states and/or RRC modes, for example including RRC-Connected state, RRC-Inactive state, and/or RRC-Idle state. A WTRU may be operating in an RRC-Connected state, during which the WTRU may have connected, established RRC context, and/or have at least one RRC connection, for example, to one or more cells, base stations, gNBs, TRPs, etc. In RRC-Connected state, the WTRU may receive RRC context and/or one or more configuration information at least including one or more radio bearers, logical channels, PDU sessions, security information, etc. During RRC-Connected state, the connected WTRU may measure one or more reference signal received power (RSRP), reference signal received quality (RSRQ), received signal strength indicator (RSSI), etc. based on one or more received, detected, configured, and/or indicated reference signals (RSs) received from serving cell and/or one or more neighboring cells. The connected WTRU may report the measured parameters, for example to the serving cell.

A WTRU may be operating in an RRC-Idle state, that may be the initial mode when the WTRU is powered up. The WTRU is RRC-Idle state is in a dormant state where the WTRU is not actively engaged in communication. The WTRU in RRC-Idle state may perform cell selection and/or cell reselection, where the WTRU receives, detects, measures, and/or selects an SSB, based on which the WTRU uses the physical broadcast channel (PBCH), master information block (MIB), system information block (SIB), etc. The WTRU in RRC-Idle state may monitor the PDCCH (e.g., DCI, Format 1-0 using the paging Radio Network Identifier (P-RNTI) defined by the Discontinuous Reception (DRX) pattern. The WTRU may use respective 5G-S-TMSI to receive Paging messages in RRC-Idle state.

A WTRU may be operating in an RRC-Inactive state, where the WTRU keeps the RRC context and CORE network connection and do not release the RRC when switching from RRC-Connected state to RRC-Inactive state. The WTRU in RRC-Inactive state may be in a sleep mode, similar to RRC-Idle state, where the mobility may be handled through cell reselection without involvement of network.

Herein, downlink reception may be used interchangeably with Rx occasion, PDCCH, PDSCH, SSB reception, but still consistent with this example embodiments and solutions disclosed herein. Herein, uplink transmission may be used interchangeably with Tx occasion, PUCCH, PUSCH, Physical Random-Access Channel (PRACH), SRS transmission, but still consistent with example embodiments and solutions disclosed herein. Herein, time instance, slot, symbol, and subframe may be used interchangeably, but still consistent with this example embodiments and solutions disclosed herein. Herein, UL-only and DL-only transmission/reception (Tx/Rx) occasions may interchangeably be used with legacy TDD UL or legacy TDD DL, respectively, and still consistent with example embodiments and solutions disclosed herein. In an example, the legacy TDD UL transmission or legacy DL reception occasions are the cases where SBFD is not configured and/or where SBFD is disabled.

Herein, the terms received signal power, received signal energy, received signal strength, SSB Energy Per Resource Element (EPRE), CSI EPRE, RSRP, RSSI, signal-to-interference-plus-noise ratio (SINR), reference signal received quality (RSRQ), SS-RSRP, SS-RSSI, SS-SINR, SS-RSRQ, CSI-RSRP, CSI-RSSI, CSI-SINR, and CSI-RSRQ may be used interchangeably, but still consistent with example embodiments and solutions disclosed herein. Herein, the term CLI may be used interchangeably with interference, and still consistent with example embodiments and solutions disclosed herein. Herein, the term non-SBFD may be used interchangeably with operation without SBFD, TDD, legacy TDD, and still consistent with example embodiments and solutions disclosed herein. Herein, the terms ‘paired spectrum’ and FDD may be used interchangeably, but still consistent with example embodiments and solutions disclosed herein. Herein, the terms ‘unpaired spectrum’ and TDD may be used interchangeably, but still consistent with example embodiments and solutions disclosed herein. Herein, the terms ‘WTRU is configured’, ‘WTRU is indicated’, ‘WTRU receives configuration’, may imply that the configuration is indicated for example ‘via RRC, MAC-CE, DCI, MIB, SIB’, unless indicated otherwise, where for example, ‘WTRU is configured’ may imply ‘WTRU is configured via RRC, MAC-CE, MIB, SIB’.

Herein, the terms target and candidate may be used interchangeably, and still consistent with example embodiments and solutions disclosed herein. For example, the terms target cell and candidate cell may be used interchangeably. In another example, the terms target beam and candidate beam may be used interchangeably. For illustrative purposes, the channel quality parameters may comprise the RSRP, however the example embodiments and solutions disclosed herein may equally (or equivalently or extendedly, etc.) be employed (e.g., applicable) for cases with other quality parameters and/or values (e.g., RSRQ, SINR, etc.).

Subband non-overlapping full duplex (SBFD) is described herein. A WTRU may receive configurations (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs a UL transmission or a DL reception (e.g., not both UL and DL simultaneously at the given time). The WTRU may (also) operate in an FD mode for communicating with the gNB (e.g., if a corresponding WTRU capability signal(s) is reported to the gNB and/or the WTRU receives a confirmation signal (e.g., enabling the FD, configuring the FD mode) in response to transmitting the WTRU capability signal(s)).

The FD operation may imply at a given time a transmitter (e.g., the gNB and/or the WTRU) may simultaneously transmit a first signal and receive a second signal. The FD operation may comprise a subband overlapping FD (e.g., in-band FD (IBFD)) operation where a first frequency-domain resource (e.g., resource block group (RBG) (s), resource block (RB) (s), resource element (RE) (s)) allocated for the first signal may have a full (or at least a partial) overlap with a second frequency-domain resource allocated for the second signal. The FD operation may comprise a subband non-overlapping FD (SBFD) operation where a first frequency-domain resource allocated for the first signal (e.g., assigned within a configured SBFD subband (e.g., DL subband, usable DL PRBs) does not have an overlap with a second frequency-domain resource allocated for the second signal (e.g., assigned within a configured SBFD subband, for example an UL subband, and/or usable UL PRBs).

Herein, for illustrative purposes, the FD operation may comprise the SBFD operation, however the example embodiments and solutions disclosed herein may equally (or equivalently or extendedly, etc.) be employed (e.g., applicable) for cases with other FD operation types (e.g., IBFD, etc.).

A WTRU may be configured with one or more types of slots within a bandwidth, wherein a first type of slot may be used or determined for a first direction (e.g., downlink); a second type of slot may be used or determined for a second direction (e.g., uplink); a third type of slot may have a first group of frequency resources within the bandwidth for a first direction and a second group of frequency resources within the bandwidth for a second direction. Herein, the bandwidth may be interchangeably used with bandwidth part (BWP), carrier, subband, and system bandwidth. The first type of slot (e.g., the slot for a first direction) may be referred to as downlink slot. The second type of slot (e.g., slot for a second direction) may be referred to as uplink slot. The third type of slot may be referred to as Sub-Band (non-overlapping) Full Duplex (SBFD) slot. The group of frequency resource for a first direction may be referred to as downlink subband, downlink frequency resource, or downlink RBs. The group of frequency resource for a second direction may be referred to as uplink subband, uplink frequency resource, or uplink RBs. The group of frequency resource for a flexible direction (e.g., that may be configured for a first direction, second direction, etc.) may be referred to as flexible subband, flexible frequency resource, or flexible RBs. The group of frequency resource between a first direction and a second direction may be referred to as guard band, guard frequency resource, or guard RBs.

In an example, a (SBFD-enabled) WTRU may receive or be configured with one or more SBFD UL or DL subbands in one or more DL, UL, and/or flexible TDD time instances (e.g., symbols, slots, frames). The WTRU may be configured with one or more resource allocations for SBFD subbands.

For example, the SBFD configuration may include a flag signal (e.g., enabled/disabled), where for example a first value (e.g., zero (0) indicates a first mode of operation (e.g., based on SBFD resources and/or configurations), and a second value (e.g., one (1) may indicate a second mode of operation (e.g., based on non-SBFD resources and/or configurations). The modes of operation (e.g., SBFD or non-SBFD) may be indicated via, for example MIB, SIB, RRC, MAC-CE, DCI.

Herein, the term “WTRU operating based on SBFD operation” may indicate WTRU performing Tx/Rx based on SBFD resources and/or configurations. Herein, the term “WTRU operating based on non-SBFD operation” may indicate WTRU performing Tx/Rx based on non-SBFD resources and/or configurations.

The WTRU may receive the time resources (e.g., one or more symbols, slots), for which the first mode of operation (e.g., SBFD) is defined in for example one or more BWPs, subbands, component carriers (CC), cells. The WTRU may receive the frequency resources (e.g., subbands, BWPs, etc. including one or more PRBs) within (active and/or linked) BWP, for which the first mode of operation (e.g., SBFD) is configured. The time instances (e.g., slots, symbols) may be indicated based on periodic, semi-persistent, or aperiodic configurations. In an example, the time instances may be indicated via a bitmap configuration, where each bit corresponds to a time instance (e.g., slot, symbol, subframe, etc.) and each bit indication indicates whether corresponding time instance may be used for the first or second mode of operation.

In an example, a WTRU may be configured with a DL TDD configuration for a component carrier (CC) or a BWP for one or more Rx occasions (e.g., via tdd-UL-DL-config-common, dedicated configurations, slot format indicator (SFI). As such, if the first mode of operation (e.g., SBFD) is configured, one or more of the configured frequency resources (e.g., subbands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations, slot format indicator (SFI)). As such, if the first mode of operation (e.g., SBFD) is configured, one or more of the configured frequency resources (e.g., subbands, PRBs, and/or BWPs) may be configured as the DL channels and/or Rx occasions.

In another example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI)). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

In an example, the duplexing mode for the first mode of operation (e.g., SBFD configuration (UL/DL)) may be indicated via a flag indication, where for example a first value (e.g., zero (0) may indicate a first direction (e.g., UL duplexing mode), and a second the value (e.g., one (1)) may indicate a second direction (e.g., DL duplexing model). In an example, the duplexing mode configuration and/or flag for the first mode of operation (e.g., SBFD) may be configured as part of modes of operation configuration, for example via MIB, SIB, RRC, DCI, MAC-CE, etc. In an example, the duplexing mode configuration and/or flag for the first mode of operation (e.g., SBFD) may be configured as part of resource allocation configuration for a Tx/Rx occasion.

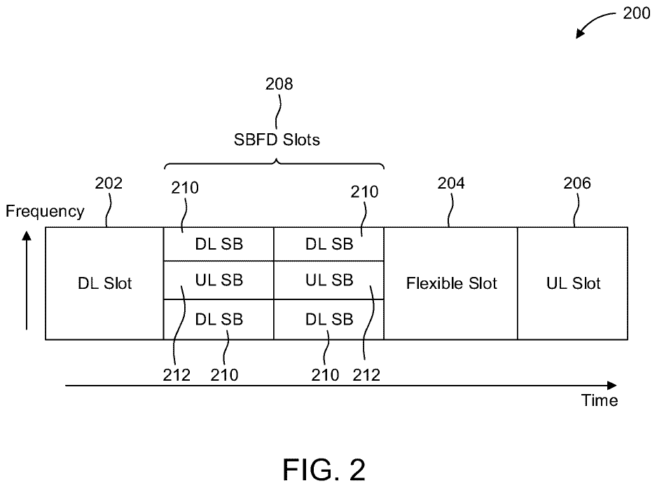

In an example, the WTRU may be configured with DUD configuration, where an UL subband is configured between two DL subbands (See for example FIG. 2). In another example, the WTRU may be configured with UD configuration, where an UL subband is configured with higher frequencies followed by a DL subband with lower frequencies. In another example, the WTRU may be configured with DU configuration, where a DL subband is configured with higher frequencies followed by au UL subband with lower frequencies. These examples are non-limiting examples of the SBFD configurations and parameters that may be included in SBFD configurations. One or more of those configurations may be included. Other configurations may be included.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (e.g., SBFD), the WTRU may be configured with one or more DL, UL, flexible, guard, etc. subbands in the frequency domain, throughout the BWP, for the duration of the first slot. In the second slot with the second type (e.g., non-SBFD), the WTRU may be configured with direction type, for example DL, UL, flexible, etc., in the frequency domain, throughout the BWP, for the duration of the second slot.

In an example, if the WTRU is configured with a second slot with UL direction, this may indicate legacy TDD UL slot, UL-only slot, and/or non-SBFD UL slot. In another example, if the WTRU is configured with a third slot with second type (e.g., non-SBFD) with DL direction, this may indicate legacy TDD DL slot, DL-only slot, and/or non-SBFD DL slot. In another example, if the WTRU is configured with a fourth slot with second type (e.g., non-SBFD) with flexible direction, this may indicate legacy TDD flexible slot and/or non-SBFD flexible slot.

CLI measurement is described herein. A WTRU may be configured, determined, or indicated to perform a measurement of cross-link interference (CLI) Received Signal Strength Indicator (RSSI) in a given time period, wherein the given time period may be one or more slots, OFDM symbols, resource blocks (RBs), and/or resource elements (REs). The CLI-RSSI, which may be measured in a given time and/or frequency resource, may be referred to as L1-CLI-RSSI, short-term CLI-RSSI, aperiodic CLI-RSSI. Alternatively, the WTRU may be configured, determined, or indicated to perform a measurement of Reference Signal Received Power (RSRP) based on one or more reference signals (e.g., SRS-RSRP) in the context of CLI measurement in a given time period, wherein the given time period may be one or more slots, OFDM symbols, resource blocks (RBs), and/or resource elements (REs). The SRS-RSRP which may be measured in a given time and frequency resource may be referred to as L1-SRS-RSRP, short-term SRS-RSRP, aperiodic SRS-RSRP, SRS-RSRP-CLI.

Herein, the terms CLI-RSSI, L1-CLI-RSSI, and RSSI may be interchangeably used but still consistent with the example embodiments and solutions disclosed herein. Herein, the terms SRS-RSRP, SRS-RSRP-CLI, L1-SRS-RSRP, and RSRP may be interchangeably used but still consistent with the example embodiments and solutions disclosed herein.

L1/L2 CLI measurement is described herein. One or more RSSI (or RSRP) types may be used and a WTRU may be configured to perform one or more RSSI (or RSRP) types, wherein a first RSSI (or RSRP) type may be based on a measurement over a long time period (e.g., more than one slot) (e.g., L3 measurements) and the measurement is reported via a higher layer signaling (e.g., RRC, MAC). A second RSSI (or RSRP) type may be based on a measurement over a short time period (e.g., L1 measurements) (e.g., one slot, within a slot, one or more OFDM symbols within a slot) and the measurement is reported via a L1 signaling (e.g., PUCCH, PUSCH, Random Access Channel (RACH), SRS). RSSI may be interchangeably used with RSRP, RSRQ, and SINR. CLI-RSSI may be interchangeably used with SRS-RSRP and SINR.

The WTRU may be configured with one or more sets of time and frequency resources for measuring CLI (e.g., SRS-RSRP) (e.g., a new IE SRS-RSRP-MeasurementResourceSet) containing one or more sets of configuration information of SRS-RSRP measurement resource(s) (e.g., SRS-RSRP-MeasurementResource), for example for L1 SRS-RSRP measurement. The SRS-RSRP measurement resource configurations may include number of SRS ports, transmission comb, time resource mapping such as start position, number of symbols, repetition, frequency resources, frequency hopping, resource type such as periodic, aperiodic, semi-persistent, sequence ID used for SRS.

The WTRU may be configured with one or more sets of time and frequency resources for measuring CLI (e.g., CLI-RSSI) (e.g., a new IE CLI-RSSI-MeasurementResourceSet) containing one or more sets of configuration information of CLI-RSSI measurement resource(s) (e.g., CLI-RSSI-MeasurementResource), for example for L1 CLI-RSSI measurement. The CLI-RSSI measurement resource configurations may include CLI-RSSI measurement resource ID, starting PRB index, number of PRBs, starting symbol of the CLI-RSSI resource within a slot, number of symbols of the CLI-RSSI resource within a slot, periodicity and slot offset for the CLI-RSSI resource.

The WTRU may be configured with a set of time and frequency resources to measure L1-CLI-RSSI, wherein the time and frequency resources for L1-CLI-RSSI measurement may be referred to as CLI-RSSI Measurement Resource (CRMR). For example, CRMR may be a resource configured, determined, or defined (e.g., via RRC, MAC-CE, DCI) (e.g., via CLI-ResourceConfig, CLI-ResourceConfig-r-16) with any one or more of following example properties. An example property includes a set of muted resource elements (REs) in downlink resource (e.g., PDSCH), wherein the muted REs may be rate-matched around or punctured for downlink reception and/or uplink transmission. The set of muted REs may have a same pattern (e.g., same time and frequency location) in each resource block (RB). The set of muted REs may have a different pattern based on the RB location. For example, a first pattern may be used for the RBs located in an edge of the scheduled RBs and a second pattern may be used for the RBs located in a center of the scheduled RBs. The first pattern and the second pattern may have a different number of muted REs. The muted REs may be in a form of zero-power resources (e.g., CSI-RS and/or ZP-CSI-RS).

An example property includes a set of REs not scheduled or used for the WTRU measuring CRMR. An example property includes a set of REs may be located in an RB which may be configured or determined as guard band (or guard RB). For example, a guard band (or guard RB) may be located in between uplink and downlink resources. A WTRU may skip receiving or transmitting a signal in guard band.

An example property includes a one or more reference signals (e.g., DMRS, SRS, sidelink CSI-RS, etc.).

An example property includes a second set of DMRS REs within a second code division multiplexing (CDM) group (e.g., within a scheduled downlink resource and/or RBs, for example of PDSCH), where a WTRU may receive a DCI, scheduling the PDSCH, indicating a first set of DMRS REs corresponding to a first CDM group to be used for receiving the PDSCH. In an example, the WTRU may receive the DCI, scheduling the PDSCH, indicating a first set of DMRS REs corresponding to a first CDM group (based on an indicated ‘(DMRS) antenna port’ field of the DCI. In response to receiving the DCI, the WTRU may determine that a second set of DMRS REs within a second CDM group (other than the first CDM group) may be used as the CRMR (e.g., within the scheduled PDSCH). An example property includes located within a scheduled resource (e.g., scheduled PDSCH RBs).

CRMR may be configured commonly for a set of WTRUs (e.g., WTRUs in proximity). For example, a gNB may configure a CRMR for a group of WTRUs, wherein the group of WTRUs may share one or more of following: a group-ID to receive a DCI (e.g., a group-Radio Network Identifier (group-RNTI)); a zone-ID, wherein the zone-ID may be determined based on a geographical location of the WTRU (e.g., GNSS); and/or WTRUs paired for sidelink unicast (or groupcast) transmission.

L1-CLI-RSSI measurement (including CRMR resource) may be considered as CSI reporting quantity and configured as a part of CSI reporting setting. CRMR may be configured in a first subband type (e.g., DL subbands) to measure the (effect of) one or more reference signals received in a second subband type (e.g., UL subbands). As such, the reference signals may be received and measured in resources that may be identified as zero-power or muted resources. The WTRU may be configured, determined, or indicated to measure the effect of reference signals being transmitted in other resources (e.g., second type resources, such as UL subbands) in these resources (e.g., first type resources, such as DL subbands). For example, a first WTRU may be configured to measure SRS-RSRP in DL subbands on an SBFD configuration, where the SRS is transmitted by a second WTRU in the UL subbands. In an example, the first WTRU may measure SRS-RSRP based of the configured SRS signaling in the DL subbands. In another example, the WTRU may measure the CLI-RSSI based on the configured SRS signaling in the UL subbands.

Delta-CLI measurement is described herein. The WTRU may be configured, determined, or indicated to perform a delta CLI-RSSI, which may be based on a first CLI-RSSI measurement in a first time and/or frequency location and a second CLI-RSSI measurement in a second time and/or frequency location. One or more of following deltas may apply. An example delta is the delta CLI-RSSI (delta-CLI-RSSI) may be a difference between a first CLI-RSSI (e.g., CLI-RSSI1) and a second CLI-RSSI (e.g., CLI-RSSI2) (e.g., delta-CLI-RSSI=CLI-RSSI1-CL-RSSI2 (or delta-CLI-RSSI=CLI-RSSI2−CL-RSSI1, etc.)). Another example delta is the first CLI-RSSI may be measured from CRMR resources located in the edge of the scheduled RBs while the second CLI-RSSI may be measured from CRMR resources located in the middle of the scheduled RBs. Another example delta is a WTRU may be configured with a first CRMR resource for the first CLI-RSSI measurement and a second CRMR resource for the second CLI-RSSI measurement. Another example delta is a WTRU may determine to report CLI measurement related information when a measured delta-CLI-RSSI is larger than a threshold. For example, CLI reporting may be triggered based on delta-CLI-RSSI measurement is larger than a threshold, wherein the threshold may be predetermined or configured.

Bandwidth and/or Subband configuration for CLI measurement is described herein. The WTRU may be configured or may determine to measure CLI-RSSI per subband level. For example, a subband may be configured, or predetermined and a WTRU may perform CLI-RSSI measurement in each subband. One or more of following considerations may apply. In an example, subband size may be determined based on the number of scheduled RBs (e.g., for PDSCH). In another example, the WTRU may report CLI-RSSI measurement for all subbands. In another example, the WTRU may report a subset of CLI-RSSI, wherein the subset may be determined based on one or more conditions (e.g., CLI-RSSI value above threshold, subband location (e.g., edge of scheduled RBs), and/or subband index).

The WTRU may determine a bandwidth of beam measurement and/or reporting (e.g., wideband or subband) based on any one or more of following conditions: Time unit type (e.g., SBFD or non-SBFD), for example, a WTRU may report wideband CRI (e.g., wideband beam index) in non-SBFD time units (e.g., symbol, slot) and the WTRU may report subband CRI (e.g., subband beam index) in SBFD time units; and/or presence of CLI-RSSI measurement, for example the bandwidth of beam measurement/reporting is determined based on whether CLI-RSSI is measured in the same slot or not.

The WTRU may be indicated to perform CLI-RSSI measurement in a specific frequency location within a scheduled RBs (or non-scheduled RBs), wherein the specific frequency location may be one or more of subbands, RBs, and REs. The indication may be in a DCI which may trigger the CLI-RSSI measurement (e.g., aperiodic CLI-RSSI measurement). The specific frequency location may be indicated based on the CRMR resource frequency location. For example, one or more CRMR resources may be configured and each CRMR resource may be located in a specific frequency location based on configuration. The WTRU may be indicated to perform measurement on CRMR resource indicated in a DCI.

SRS Types are described herein. The WTRU may be configured or indicated to transmit one or more SRSs, where an SRS resource of the one or more SRSs may be configured for a particular purpose of at least one of: beam management, channel acquisition (e.g., based on channel reciprocity), link adaptation, antenna switching. The mentioned particular purpose may be interpreted to be for a communication link between the WTRU and a gNB (e.g., its serving gNB, cell, TRP, or a target cell, gNB, TRP during cell switching, etc.), which may be denoted by a first SRS type. The first SRS type is a non-limiting example of a type of SRS that may be used for or to support a communication link between the WTRU and its serving cell, TRP, and/or gNB.

The WTRU may be configured or indicated to transmit second one or more SRS resources at least for CLI measurement purpose at a receiver side, which may be denoted by a second SRS type (e.g., CLI-SRS). The second SRS type is a non-limiting example of a type of SRS that may be used for or to support at least the CLI measurements at a receiver side (e.g., other WTRU(s), gNB(s), other communication device and/or node in the network). Any other type of transmission may be substituted for the transmission based on the second SRS type and still be consistent with example embodiments and solutions disclosed herein. The CLI measurements at the receiver side (e.g., a second WTRU) include, but or not limited to include, any one or more of the following: an energy-level or power-level measurement (e.g., CLI-RSSI) on a configured or indicated DL resource (e.g., a form of zero-power resource, a configured CLI-measurement resource, and/or the like); a sequence-based and/or correlation-based RS power measurement (e.g., SRS-RSRP) on a configured or indicated RS sequence and/or resource (e.g., SRS resource which may be transmitted from the WTRU causing the CLI to the second WTRU); and/or a signal-to-interference-plus-noise ratio (SINR) or channel quality indicator (CQI) type of channel quality metric derivation to be reported.

Cell-Level mobility is described herein. A WTRU may determine, identify, receive, be configured, and/or indicated to perform cell switch from the WTRU's serving cell to a determined, identified, configured, and/or indicated target cell. In an example, the WTRU may be in RRC-Connected state. During RRC-Connected state, the mobility of the WTRU may be handled and/or controlled by the NW. During RRC-Connected state, the connected WTRU may perform one or more Radio Resource Management (RRM) measurements and report the RRM measurements, for example to its serving cell. The connected WTRU may receive a request, command, and/or indication to switch from the serving cell to a target and/or candidate neighboring cell.

In the case of handover (HO), a WTRU may receive, be configured, and/or indicated with a HO command from a serving cell, where the (intra-NR) RAN handover preparation and execution may be performed based on one or more message exchanges, for example between gNBs. For example, the WTRU may determine, be configured, and/or indicated to reset the MAC entity and re-establish RLC, etc. during handover mechanism triggered by RRC. In an example, during HO preparation, the source and target gNBs may establish in-between user-plane (U-plane) tunnels. In another example, during HO execution, user data may be forwarded from source gNB to the target gNB. In another example, the data forwarding from the source gNB may continue until UPF or the source gNB's buffer is emptied.

In the case of conditional Handover (CHO), a WTRU may receive, be configured, and/or indicated with a CHO command from a serving cell, wherein the WTRU may perform the configured and/or indicated CHO when one or more configured and/or indicated handover execution conditions are met. In an example, the WTRU may receive the HO conditions via RRC, where the WTRU may evaluate the configured and/or indicated execution conditions upon receiving the CHO configurations. For example, the WTRU may stop evaluating the conditions when the HO is accomplished. For example, the WTRU may receive CHO configurations that may be generated by serving and/or source cell in addition to CHO configurations that may be generated by candidate and/or neighboring cells. In an example, a CHO condition may include one or more trigger conditions, for example, based on one or more measured RSRP, RSRQ, RSSI, SINR, etc. In case the WTRU determines that one or more of the CHO conditions for a candidate and/or target cell are satisfied, the WTRU may initiate HO to the corresponding target cell. In an example, the data forwarding between the source and target gNBs may be accomplished before or after HO execution, which may be addressed as early or late data forwarding, respectively.

In the case of L1/L2 Triggered Mobility (LTM), a WTRU may receive, be configured, and/or indicated to perform LTM cell switch to a candidate and/or target cell. For example, the WTRU may receive, identify, be configured, and/or indicated to send (L1) (RRM) measurement reports, for example to a gNB, where the gNB may change WTRU's serving cell to a target and/or candidate cell, via an LTM cell switch command, for example signaled by MAC-CE signaling. As part of the cell switch command, the WTRU may receive an indication to an LTM candidate (pre) configuration, for example regarding an LTM target cell, where the WTRU may have received the (pre) configured configuration information, for example via semi-static configurations (e.g., via RRC signaling). As such, the WTRU may switch to the configured and/or indicated LTM target cell based on the received LTM cell switch command.

A WTRU may be configured and/or indicated to initiate UL timing advance (TA) acquisition before LTM cell switching procedure, as in preparation phase. In an example, the WTRU may be indicated to send a PRACH to one or more candidate cells, where the WTRU may receive the indication, for example by a PDCCH order. As such, the WTRU may receive the TA command as part of LTM cell switch command. In another example, the WTRU may be configured and/or indicated to measure TA.

Depending on the availability of a valid TA value, a WTRU may perform either a RACH-less LTM or RACH-based LTM cell switch. In case the WTRU is provided with a valid TA value, for example in the cell switch command, the WTRU may apply the indicated TA value. In the case where WTRU-based TA measurement is configured and the WTRU is not provided with a valid TA value in the cell switch command, the WTRU may apply the valid TA value by itself. Therefore, the WTRU may perform RACH-less LTM cell switch upon receiving the cell switch command. If no valid TA value is available, the WTRU may perform RACH-based LTM cell switch toward the indicated target cell, where the WTRU may transmit the PRACH preamble indicated in LTM cell switch command, based on the indicated SSB index and PRACH Mask index.

In RACH-less LTM, a WTRU may access a target cell using one or more configured and/or dynamic grants. For example, the WTRU may be (pre) configured with the configured grant (e.g., including corresponding time-domain resource allocations (TDRA), frequency-domain resource allocations (FDRA), etc.), for example via the LTM candidate configuration (e.g., via RRC signaling). In an example, the WTRU may select the configured grant occasion associated with the beam indicated in the cell switch command (e.g., via indicated UL and/or DL TCI states). In an example, after LTM cell switch to the target cell, the WTRU may start monitoring PDCCH on the target cell for dynamic scheduling.

In an example, a WTRU performing LTM cell switch mechanism, for example triggered by MAC-CE, may reset the MAC entity, where the radio link control (RLC) and packet data convergence protocol (PDCP) handling may be configured, for example via RRC configuration.

Conditional layer 1/layer 2 (L1/L2) Triggered Mobility (LTM) is disclosed herein. A WTRU may receive, be configured, and/or indicated with a conditional LTM cell switch command from a serving cell, wherein the WTRU may perform the configured and/or indicated conditional LTM cell switch when one or more configured and/or indicated LTM cell switch conditions are met. In an example, the WTRU may receive the conditional LTM cell switch conditions via RRC, where the WTRU may evaluate the configured and/or indicated execution conditions upon receiving the conditional LTM cell switch configurations. For example, the WTRU may stop evaluating the conditions when the LTM cell switch is accomplished. For example, the WTRU may receive conditional LTM cell switch configurations that may be generated by serving and/or source cell in addition to conditional LTM cell switch configurations that may be generated by candidate and/or neighboring cells. In an example, a conditional LTM cell switch condition may include one or more trigger conditions, for example, based on one or more measured RSRP, RSRQ, RSSI, SINR, etc. In case the WTRU determines that one or more of the conditional LTM cell switch conditions for a candidate and/or target cell are satisfied, the WTRU may initiate LTM cell switch to the corresponding target cell. In an example, the data forwarding between the source and target gNBs may be accomplished before or after LTM cell switch, which may be addressed as early or late data forwarding, respectively.

Herein, the term “LTM cell switch” may interchangeably be used with HO, CHO, and conditional LTM cell switch, but still consistent with the example embodiments and solutions disclosed herein. Herein, for illustrative purposes, the cell switching operation may comprise the LTM cell switching operation, however the example embodiments and solutions disclosed herein may equally (or equivalently or extendedly, etc.) be employed (e.g., be applicable) for cases with other cell switching operations (e.g., HO, CHO, conditional LTM, etc.).

L1 measurement is disclosed herein. An L1 measurement herein may consist of a measurement of RSRP, RSRP, RSSI, etc., performed by a WTRU of a cell, beam, set of cells, or set of beams. Such L1 measurement may be similar to L3 measurements reported in RRM, with differences in the filtering, reference signals measured, reporting mechanisms, etc. L1 measurement may apply also to RRM reporting. Herein, measurements refer to L1 measurements for LTM. However, certain solutions herein may apply also to RRM/L3 measurements, as well as other measurements (e.g., measurements of speed, location, height, traffic). Herein, reference is made to L1 measurement events, and L1 LTM mobility events, which use separate reporting mechanisms, resources, and triggers. However, certain solutions herein may also apply to any other type of measurement events of separate types which interact either in terms of the reporting mechanism or the evaluation mechanism.

LTM cell switch may apply also to any type of handover execution. Herein, the LTM cell switch refers to L1/L2 triggered mobility (LTM) whereby a preconfigured RRC configuration is applied when the WTRU receives an indication using MAC CE or when a certain condition is met at the WTRU. However, certain solutions may also apply to an RRC reconfiguration, an RRC conditional reconfiguration, as well as any other type of mobility procedure. LTM execution trigger herein refers to a condition for performing LTM (e.g. a conditional handover trigger or measurement report trigger), which is either configured or indicated by the network to the WTRU or estimated and/or determined by the WTRU.

An LTM execution trigger may be based on any of the following example triggers. An example trigger is time (e.g., absolute or relative time measured at WTRU, system frame number (SFN), subframe number, etc.). Another example trigger is radio quality measurement or predicted radio quality of one or more of the serving cells or target cells. Radio quality measurement or predicted radio quality triggers may include: RSRP (beam or cell); RSRQ (beam or cell); cri-RI-PMI-CQI; cri-RI-i1; cri-RI-i1-CQI; cri-RI-CQI; cri-RSRP; ssb-Index-RSRP; cri-RI-L1-PMI-CQI.

Another example trigger is position, which may include an area (e.g. defined by reference point and radius) or range of co-ordinates, and/or a distance threshold from a reference location. Another example trigger is L3 measurement events, which may include any of the following example events: Event A1 (Serving becomes better than threshold); Event A2 (Serving becomes worse than threshold); Event A3 (Neighbor becomes offset better than special cell (SpCell)); Event A4 (Neighbor becomes better than threshold); Event A5 (SpCell becomes worse than threshold1 and neighbor becomes better than threshold2); Event A6 (Neighbor becomes offset better than secondary cell (Scell)); Event B1 (Inter RAT neighbor becomes better than threshold); and/or Event B2 (primary cell (Pcell) becomes worse than threshold1 and inter RAT neighbor becomes better than threshold2). Another example trigger is L1 measurement event or conditions, for example any event defined which utilizes L1 beam measurements to evaluate whether a criteria or condition is met. For example, for LTM: Event LTM1: Beam of serving cell becomes better than absolute threshold; Event LTM2: Beam of serving cell becomes worse than absolute threshold; Event LTM3: Beam of candidate cell becomes amount of offset better than beam of serving cell; Event LTM4: Beam of candidate cell becomes better than absolute threshold; and/or Event LTM5: Beam of serving cell becomes worse than absolute threshold1 AND Beam of candidate cell becomes better than another absolute threshold2.

Another example trigger is time or location-based conditions, for example: Time measured at WTRU is within a duration from threshold; Distance between WTRU and referenceLocation1 is above threshold1 and distance between WTRU and referenceLocation2 is below threshold2; and/or Distance between WTRU and the serving cell moving reference location is above threshold1 and distance between WTRU and a moving reference location is below threshold2.

Another example trigger is combination of L3, L1, time, location-based conditions or events. For example, time measured at WTRU is within a duration from threshold AND Beam of candidate cell becomes better than absolute threshold, and so on. In another example, distance between WTRU and referenceLocation1 is above threshold1 and distance between WTRU and referenceLocation2 is below threshold2 AND Beam of candidate cell becomes amount of offset better than beam of serving cell. In another example, Distance between WTRU and the serving cell moving reference location is above threshold1 and distance between WTRU and a moving reference location is below threshold2 AND Beam of serving cell becomes worse than absolute threshold1 AND Beam of candidate cell becomes better than another absolute threshold2.

Cell (Re) Selection procedures are described herein. A WTRU may perform cell selection with or without stored cell information. The cell information may include frequencies and/or cell parameters. In an example, a cell may be defined as a combination of one or more uplink component carriers (CC) and one or more downlink component carriers. The WTRU may have (previously) stored information on one or more cells based on previously received measurement control information elements or from previously detected cells. If the WTRU has stored cell information, the WTRU may leverage it for cell selection.

In case there is no stored information, or if cell search based on the stored information has no results, the WTRU may perform initial cell selection, where the WTRU has no prior knowledge of the cell parameters. For example, the WTRU may not have knowledge of which RF channels are NR frequencies. As such, the WTRU may scan and/or monitor one or more RF channels for example from a set of RF channels (e.g., based on the synchronization raster frequencies) in the NR bands to find a suitable cell. For example, a synchronization raster may indicate the frequency positions of the synchronization block (e.g., SS/PBCH block) that may be used by the WTRU for system acquisition when explicit signaling of the synchronization block position is not present. As such, the WTRU may search to find the SS/PBCH blocks corresponding to one and more cells on each frequency channel and/or raster, where the WTRU may select the strongest cell based on the measuring the RSSI, RSRP, RSRQ, SINR for the detected SS/PBCH block.

Herein, the term ‘evaluated parameter’ may be used interchangeably with ‘evaluated RSRP’, ‘evaluated RSRQ’, where the term evaluated may be interpreted as adjusted, computed, calculated, compensated, scaled, defined, determined, identified. As such, a WTRU may determine an evaluated parameter based on one or more measured values along with one or more compensation and/or scaling parameters (e.g., (pre) configured and/or indicated parameters). The WTRU may calculate the addition, subtraction, multiplication, and/or division of one or more measured values with one or more compensation and/or scaling parameters to determine the corresponding evaluated parameter.

Upon finding a suitable cell, based on criteria for a suitable cell, the WTRU may select the suitable cell as the serving cell. In an example, the WTRU may use one or more criteria to select a candidate cell as a suitable cell. The WTRU may determine the criteria based on one or more evaluated parameters. The WTRU may determine the evaluated parameters based on one or more of measured parameters, compensation values, scaling rules. In an example, the WTRU may determine the compensation values and/or scaling rules based on one or more configured and/or indicated offsets, parameters, configured values. In an example, the WTRU may be configured with, or determine any one or more of the following example parameters for determining criteria for a suitable cell. An example parameter is measured cell received level value. For example, the WTRU may measure the reference signal received power (RSRP), signal-to-noise and interference ratio (SINR), received signal strength indicator (RSSI) for one or more SS/PBCH blocks, reference signals, and/or channels. Another example parameter is measured cell quality value. For example, the WTRU may measure the reference signal received quality (RSRQ) for one or more SS/PBCH blocks, reference signals, and/or channels. Another example parameter is minimum required measured RX level and/or quality level in a cell. For example, a WTRU may receive, determine, or be configured with one or more parameters and/or offset values to determine the minimum required Rx level (e.g., in dBm) and/or minimum required quality level (e.g., dB) in the corresponding cell.

Another example parameter is compensation values. For example, the WTRU may receive, determine, or be configured with one or more parameters, offset, and/or scaling values that may be used upon receiving an indication, or based on WTRU determining based on one or more modes of operation, thresholds. Another example parameter is evaluated cell (re)selection Rx level value. For example, the WTRU may compute, evaluate, and/or calculate the received level value (e.g., in dB) based on one or more measured parameters and/or compensation and/or scaling values. In an example, the WTRU may calculate the evaluated cell (re)selection Rx level value (e.g., Srxlev) based on the measured cell received level value (e.g., Qᵣₓₗₑᵥₘₑₐₛ), the minimum required measured Rx level (e.g., Qᵣₓₗₑᵥₘᵢₙ and/or Q_{rxlevminoffset}), the compensation parameters (e.g., P compensation), one or more temporary offset values (e.g., Q_{offsettemp}) (e.g., Srxlev=Qₙₓₗₑᵥₘₑₐₛ−(Qᵣₓₗₑᵥₘᵢₙ+Q_{rxlevminoffset})−P_{compensation}−Q_{offsettemp}). As such, the WTRU may select the corresponding cell as one of the candidate suitable cells if the evaluated cell (re)selection Rx level value is higher than a (pre) configured threshold (e.g., Srxlev>0 for cell selection, or Srxlev>SintraSearchP or Srxlev>SnonIntraSearchP for intra-frequency and inter-frequency, respectively, cell reselection).

Another example parameter is evaluated cell (re)selection quality value. For example, the WTRU may compute, evaluate, and/or calculate the received quality value (e.g., in dB) based on one or more measured parameters and/or compensation and/or scaling values. In an example, the WTRU may calculate the evaluated cell (re)selection quality value (e.g., Squal) based on the measured cell quality value (e.g., Q_{qualmeas}), the minimum required quality level (e.g., Q_{qualmin} and/or Q_{qualminoffset}), one or more temporary offset values (e.g., Q_{offsettemp}) (e.g., Squal=Q_{qualmeas}−(Q_{qualmin}+Q_{qualminoffset})−Q_{offsettemp}). As such, the WTRU may select the corresponding cell as one of the candidate suitable cells if the evaluated cell (re)selection quality value is higher than a (pre) configured threshold (e.g., Squal>0, or Squal>SintraSearchQ, or Squal>SnonIntraSearchQ for intra-frequency and inter-frequency, respectively, cell reselection).

The WTRU may receive or be configured with one or more of the compensations and/or scaling parameters, values, settings, and/or rules as the criteria for cell (re)selection via implicit and/or explicit indications. The explicit indications may be via master information block (MIB) in corresponding SS/PBCH block, system information blocks (e.g., SIB1, SIB2, SIB3, SIB4), semi-static configuration (e.g., via RRC), dynamic indication (e.g., via MAC-CE and/or DCI). The WTRU may determine to use one or more compensation and/or scaling rules based on implicit indication, that is based on comparing one or more parameters with corresponding thresholds for instance.

Cell ranking is described herein. Upon measuring and calculating the evaluated received power and/or evaluated quality value, a WTRU may perform cell ranking for all the cells (e.g., serving and neighbor cells) that the WTRU determined as the candidate suitable cells based on the cell selection criterion. For example, the WTRU may determine the cell ranking based on the calculating the R values using average RSRP results. One or more of the following may apply. The following parameters are non-limiting examples of the parameters that may be included in cell ranking calculation and measurement. One or more of these parameters may be included. Other parameters may be included. Rₛ=Q_{meas,s}+Q_{hyst}−Q_{offsettemp}. Rₙ=Q_{meas,n}−Q_{offset}−Q_{offsettemp}. Where, Rₛ and Rₙ correspond to the serving and neighbor cells, respectively. In an example, in the above equation, Q_{hyst} may represent the mobility aspects of the WTRU. Q_{offset} may be configured with different values for intra-frequency and inter-frequency cell (re)selections, and Qmeas may be the measured RSRP quantity used in cell (re)selection. The WTRU may reselect a new candidate cell, if the new cell has higher R value than the serving cell during a (pre) configured time interval.

New Radio (NR) duplex operation may provide a foundation in improving conventional time-division duplexing (TDD) operation by enhancing UL coverage, improving capacity, reducing latency. Conventional TDD operation is based on splitting the time domain between the uplink and downlink. Full duplex, or more specifically, sub-band non-overlapping full duplex (SBFD) at the gNB within a conventional TDD band, may be used (e.g., in NR R19). FIG. 2 is a frame format diagram illustrating an example TDD framework 200 with SBFD configuration. The TDD framework 200 includes downlink (DL) slot 202 for DL transmissions, flexible slot 204 for uplink or downlink transmissions, and uplink (UL) slot 206 for UL transmission. Transmissions in the DL slot 202, flexible slot 204, and UL slot 206 use the entire frequency band. The transmission in SBFD slots 208 use subbands of the frequency band for transmissions. Specifically, DL transmissions are sent in DL subbands 210, and UL transmissions are sent in UL subbands 212.

According to an example layer 1/layer 2 (L1/L2) Triggered Mobility (LTM) LTM procedure (also referred to as a lower layer triggered mobility procedure), a gNB may receive L1 measurement report(s) from a WTRU, and based on the L1 measurement report(s) the gNB may change the WTRU's serving cell, for example by sending a cell switch command signaled via a Medium Access Control (MAC) Control Element (MAC CE). The cell switch command may indicate an LTM candidate configuration that the gNB previously prepared and provided to the WTRU through radio resource control (RRC) signaling. The WTRU may switch to the target configuration according to the cell switch command. The LTM procedure may be used to reduce the mobility latency.

When configured by the network, Transmission Configuration Index (TCI) states of one or multiple cells may be activated that are different from the current serving cell. For example, the TCI states of the LTM candidate cells may be activated in advance before any of those cells become the serving cell. This allows the WTRU to be DL synchronized with those cells, thereby facilitating a faster cell switch to one of those cells when cell switch is triggered.

The LTM channel state information (CSI) report configuration may be used to configure CSI report on the cell in which the LTM-CSI-ReportConfig information element (IE) is included. The LTM-CSI-ResourceConfig IE may indicate a list of synchronization signal blocks (SSBs) or Channel State Information-Reference Signal (CSI-RS) resources for LTM CSI measurement and reporting. Example configured parameters (e.g., as in NR Release 18) that may be included in the LTM-CSI-ReportConfig information element are provided in Table 1. Table 1 is a non-limiting example of the parameters that may be included in LTM CSI report configuration. One or more of those parameters may be included. The number of bits and choices for each parameter are examples. Other numbers of bits or choices may be used.

TABLE 1
LTM-CSI-ReportConfig information element including
example of SBFD configuration in TDD framework

-- [symbol]
--

[symbol]

| | |
|---|---|
| LTM-CSI-ReportConfig-r18 ::= | SEQUENCE { |
| ltm-CSI-ReportConfigId-r18 | LTM-CSI-ReportConfigId-r18, |
| ltm-ResourcesForChannelMeasurement-r18 | LTM-CSI-ResourceConfigId-r18, |
| ltm-ReportConfigType-r18 | CHOICE { |
| periodic-r18 | SEQUENCE { |
| reportSlotConfig-r18 | CSI-ReportPeriodicityAndOffset, |
| pucch-CSI-ResourceList-r18 | SEQUENCE (SIZE (1..maxNrofBWPs)) OF |

PUCCH-CSI-Resource
},

| | |
|---|---|
| semiPersistentonPUCCH-r18 | SEQUENCE { |
| reportSlotConfig-r18 | CSI-ReportPeriodicityAndOffset, |
| pucch-CSI-ResourceList-r18 | SEQUENCE (SIZE (1..maxNrofBWPs)) OF |

PUCCH-CSI-Resource
},

| | |
|---|---|
| semiPersistentOnPUSCH-r18 | SEQUENCE { |
| reportSlotConfig-r18 | CSI-ReportPeriodicityAndOffset, |
| reportSlotOffsetList-r18 | SEQUENCE (SIZE (1.. maxNrofUL- |

Allocations-r16)) OF INTEGER (0..128),

| | |
|---|---|
| reportSlotOffsetListDCI-0-2-r18 | SEQUENCE (SIZE (1.. maxNrofUL- |

Allocations-r16)) OF INTEGER (0..128),

| | |
|---|---|
| reportSlotOffsetListDCI-0-1-r18 | SEQUENCE (SIZE (1.. maxNrofUL- |

Allocations-r16)) OF INTEGER (0..128),

| | |
|---|---|
| p0alpha | P0-PUSCH-AlphaSetId |

},

| | |
|---|---|
| aperiodic-r18 | SEQUENCE { |
| reportSlotOffsetList-r18 | SEQUENCE (SIZE (1.. maxNrofUL- |

Allocations-r16)) OF INTEGER (0..128),

| | |
|---|---|
| reportSlotOffsetListDCI-0-2-r18 | SEQUENCE (SIZE (1.. maxNrofUL- |

Allocations-r16)) OF INTEGER (0..128),

| | |
|---|---|
| reportSlotOffsetListDCI-0-1-r18 | SEQUENCE (SIZE (1.. maxNrofUL- |

```
Allocations-r16)) OF INTEGER (0..128)
    },
    ...
  },
```

| | |
|---|---|
| ltm-ReportContent-r18 | LTM-ReportContent-r18, |

...
}

| | |
|---|---|
| LTM-ReportContent-r18 ::= | SEQUENCE { |
| nrOfReportedCells-r18 | ENUMERATED {n1,n2,n3,n4}, |
| nrOfReportedRS-PerCell-r18 | ENUMERATED {n1,n2,n3,n4}, |
| spCellInclusion-r18 | ENUMERATED {true} OPTIONAL |

[symbol]

}

[symbol]

[symbol]

[symbol]

indicates data missing or illegible when filed

Table 1: LTM-CSI-ReportConfig information element including example of SBFD configuration in TDD framework

Progress has been made with regards to SBFD systems, including the following example agreements and assumptions being made in 3GPP RAN1. Under an example working assumption, for SSB symbols configured with SBFD subbands, an option is that the SSB symbols configured with SBFD subbands are SBFD symbols. In this case, only DL receptions within DL usable Physical Resource Blocks (PRBs) may be allowed for SBFD aware WTRUs. The SSB block may be assumed to be within the DL subband.

In an example agreement, for L1 WTRU-to-WTRU cross-link interference (CLI) measurement and reporting, CLI measurements may be performed within the active DL BWP and the following are supported. In an example method, the WTRU may measure Received Signal Strength Indicator (RSSI) within DL subband (Method #1). In another example method, the WTRU may measure Reference Signal Received Power (RSRP) of aggressor WTRU within UL subband (Method #2). In another example method, the WTRU may measure RSSI within UL subband ((Method #3).

In an example agreement, for L1 WTRU-to-WTRU CLI measurement and reporting, the WTRU measuring RSSI within UL subband (Method #3) is supported. A WTRU may not be configured to perform measurement using Method #1 and Methods #3 in the same OFDM symbol. Measurement resource(s) corresponding to Methods #1 and #3 shall not be associated with the same CSI-ReportConfig.

In an example agreement, a new IE SRS-RSRP-MeasurementResourceSet may be defined containing a set of SRS-RSRP measurement resource(s) SRS-RSRP-MeasurementResource for L1 SRS-RSRP measurement.

Configuration of slot offset between the slot containing the downlink control information (DCI) that triggers a set of aperiodic SRS-RSRP resources and the slot in which the SRS-RSRP resource set may be measured. SRS-RSRP-MeasurementResource may be defined with the following parameters: Legacy sounding reference signal (SRS) Resource IE; and/or other parameters.

In an example agreement, a new IE CLI-RSSI-MeasurementResourceSet may be defined containing a set of CLI-RSSI measurement resource CLI-RSSI-MeasurementResource for L1 CLI-RSSI measurement. Configuration of the slot offset between the slot containing the DCI that triggers a set of aperiodic CLI-RSSI resources and the slot in which the CLI-RSSI resource set may be measured. CLI-RSSI-MeasurementResource may be defined with the following parameters: CLI-RSSI measurement resource identifier (ID); starting PRB index; number of PRBs; starting symbol of the CLI-RSSI resource within a slot; number of symbols of the CLI-RSSI resource within a slot; periodicity and slot offset for the CLI-RSSI resource; and/or other parameters.

Progress has been made with regards to L1/L2 Triggered Mobility (LTM) systems, with the following example agreements and assumptions being made in 3GPP RAN2. In an example agreement, an event triggered L1 measurement may be designed for the following LTM purposes: select the candidate beam/cell to trigger early synchronization; and/or select the target beam/cell and trigger LTM cell switch procedure.

In an example agreement, support the following LTM events based on beam specific quality of serving cell and candidate cells as the L1 LTM measurement events: Event LTM2: beam of serving cell becomes worse than absolute threshold; event LTM3: Beam of candidate cell becomes amount of offset better than beam of serving cell; event LTM4: Beam of candidate cell becomes better than absolute threshold; and/or event LTM5: Beam of serving cell becomes worse than absolute threshold1 AND Beam of candidate cell becomes better than another absolute threshold2.

In an example agreement, the beam config of both SSB and CSI-RS in L1 measurement resource configuration may be supported in LTM config. 1n an example working assumption, a Same RS type may be used for both serving cell and neighboring cell for event LTM3 and event LTM5.

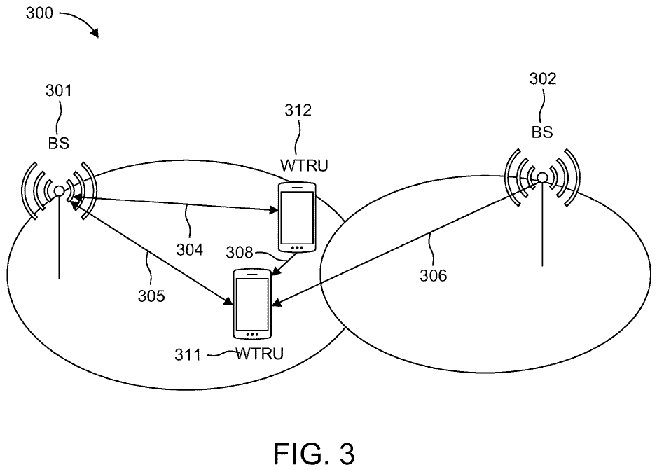

FIG. 3 is a system diagram illustrating an example radio access network (RAN) 300 illustrating an example scenario of WTRU-to-WTRU CLI in LTM systems. In the example scenario, WTRU 311 and WTRU 312 perform transmission and reception (Tx/Rx) 305 and 304 with base station (BS) 301 (e.g., gNB) as their serving cell. In general, WTRU 312 does not cause a potential cross-link interference (CLI) for WTRU 311, if WTRU 311 is performing Tx/Rx 305 with base station 301, due to WTRU 311 and WTRU's 312 beam directions. Consider WTRU 311 receiving indications on measuring SSBs from BS 302 (e.g., gNB) for LTM triggered cell switching. As WTRU 311 uses the spatial filters for receiving SSB (on beam 306) from BS 302, the UL transmission from WTRU 312 to BS 301 causes WTRU-to-WTRU CLI 308 on WTRU 311 resulting in potentially measuring lower SSB RSRP at WTRU 311, and potentially causing misdetection of the best SSB beam from BS 302. As such, in case a mobility event is configured which uses the target beam quality as one input (e.g., event LTM3), and the target beam 206 is affected by WTRU-to-WTRU CLI 308, the CLI may affect the evaluation of the mobility event. Thus, mechanisms to ensure that the accurate evaluation of LTM events is achieved in the existence of WTRU-to-WTRU CLI are desirable.

In example embodiments, procedures for CLI Mitigation for LTM Cell Switching in FD systems are described herein. In an example, it may be assumed that in SBFD systems, for SSB symbols configured with SBFD subbands, only DL receptions within DL usable PRBs are allowed for SBFD-aware WTRUs and no UL is transmitted. In an example scenario, a first WTRU uses a second beam direction to perform measurements based on SSBs from a second BS/gNB (e.g., for the purpose of LTM cell switching). Using a second beam direction puts the first WTRU at risk of WTRU-to-WTRU CLI from a second WTRU. The CLI may affect the measurements resulting in lower measured SSBs' RSRP, and may affect the evaluation of LTM events. Example procedures described herein address how to ensure that the evaluation of LTM events is accurate despite WTRU-to-WTRU CLI.

In an example solution, a first WTRU may measure received signal strength (e.g., CLI-RSSI) in the UL subband, (e.g., in the same symbol that the first SSB is received from the second cell). If the measured CLI-RSSI is higher than a threshold, the first WTRU may determine that the CLI is caused by a second WTRU in its serving cell. Based on the measured CLI-RSSI value, the first WTRU may use a second set of threshold values on the measured SSB's RSRP for determining L1 LTM measurement events. The first WTRU using different RSRP thresholds based the measured CLI caused by a second WTRU from its serving cell may enhance RSRP measurement, reporting, and best beam selection from a non-serving cell.

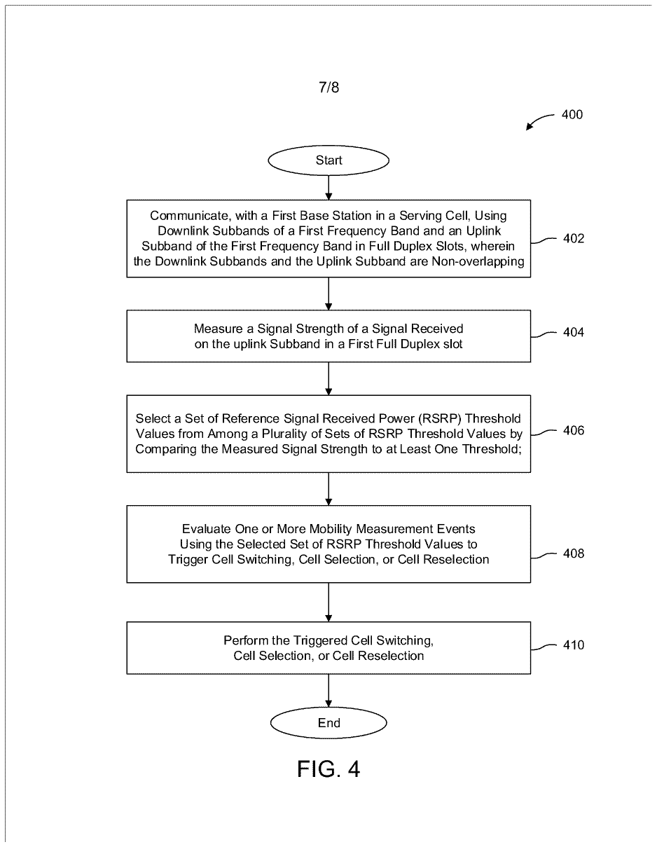

FIG. 4 is flow diagram illustrating an example LTM event evaluation procedure 400 in the presence of WTRU-to-WTRU CLI, that may be performed by a WTRU. At 402, the WTRU may communicate, with a first base station in a serving cell, using downlink subbands of a first frequency band and an uplink subband of the first frequency band in full duplex slots, wherein the downlink subbands and the uplink subband are non-overlapping. At 404, the WTRU may measure a signal strength of a signal received on the uplink subband in a first full duplex slot. At 406, the WTRU may select a set of reference signal received power (RSRP) threshold values from among a plurality of sets of RSRP threshold values by comparing the measured signal strength to at least one threshold. At 408, the WTRU may evaluate one or more mobility measurement events using the selected set of RSRP threshold values to trigger cell switching, cell selection, or cell reselection. At 410, the WTRU may perform the triggered cell switching, cell selection, or cell reselection.

Additional features that may be used in the example LTM event evaluation procedure 400, although not shown in FIG. 4, include the WTRU may further communicate, with the first base station in the serving cell, using the first frequency band in downlink slots, uplink slots, and flexible slots. The first frequency band may be a time division duplex (TDD) frequency band that permits subband non-overlapping full duplex (SBFD) operation in the full duplex slots. The signal received on the uplink subband in the first full duplex slot is cross-link interference from a second WTRU. The one or more mobility measurement events may be layer 1/layer 2 triggered mobility (LTM) measurement events and may include: a beam of the serving cell becoming worse than a first absolute threshold; a beam of a candidate cell becoming an amount of offset better than the beam of the serving cell; the beam of the candidate cell becoming better than a second absolute threshold; and the beam of the serving cell becoming worse than the first absolute threshold and the beam of the candidate cell becoming better than the second absolute threshold. The may further measure a signal strength of a synchronization signal block (SSB) signal received, from a second base station in a second cell, in one of the downlink subbands of the first frequency band, wherein the mobility measurement events are evaluated using the selected set of RSRP threshold values and the measured signal strength of the SSB signal. The SSB signal and the signal received on the uplink subband may be received in a same symbol of the first full duplex slot. The may further receive, from the first base station, radio resource control (RRC) configuration information for measuring synchronization signal block (SSB) signals in the downlink subbands of the first frequency band in the full duplex slots and reporting channel station information (CSI) based on performed measurements.

The WTRU may further send, to the first base station, a mobility report based on criteria for reporting mobility measurement events. The at least one threshold includes a first threshold, a second threshold, and a third threshold that are preconfigured. In this case, the selected set of RSRP threshold values may be a first set of RSRP threshold values when the measured signal strength is less than the first threshold; the selected set of RSRP threshold values may be a second set of RSRP threshold values when the measured signal strength is greater than the first threshold and less than the second threshold; and the selected set of RSRP threshold values may be a third set of RSRP threshold values when the measured signal strength is greater than the first threshold and greater than the second threshold. Example details of possible techniques and procedures are described further below.

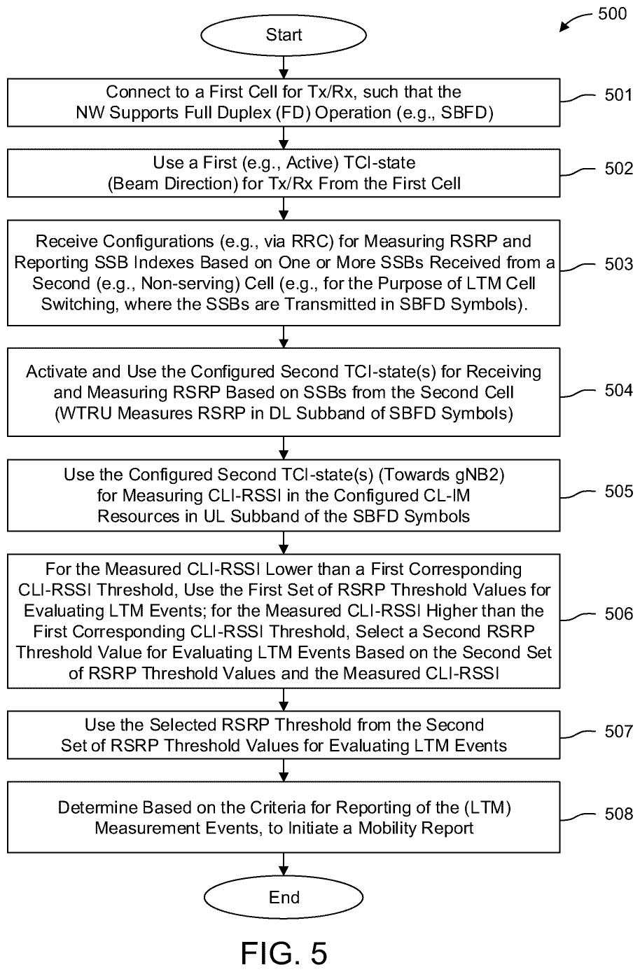

FIG. 5 is flow diagram illustrating an example detailed LTM event evaluation procedure 500 in the presence of WTRU-to-WTRU CLI, that may be performed by a WTRU. At 501, the WTRU may be connected to a first cell for Tx/Rx, such that the NW supports full duplex (FD) operation (e.g., SBFD). At 502, the WTRU may use a first (e.g., active) TCI-state (beam direction) for Tx/Rx from the first cell. At 503, the WTRU may receive configurations (e.g., via RRC) for measuring RSRP and reporting SSB indexes based on one or more SSBs received from a second (e.g., non-serving) cell (e.g., for the purpose of LTM cell switching, where the SSBs are transmitted in SBFD symbols). Example configuration may include, but are not limited to include, any of the following configurations: LTM CSI report configuration with SSB indexes to be measured in DL SB of SBFD symbols; one or more second TCI states for measuring the RSRP based on SSBs from second cell; a first and a second set of RSRP threshold values for determining LTM events (e.g., the second set of threshold values may be determined based on the first set and one or more offset or delta values); and/or LTM CL-IM resources for measuring CLI-RSSI in UL subband of (e.g., the same) SBFD symbols, in addition to one or more CLI-RSSI threshold values.

At 504, the WTRU may activate and use the configured second TCI-state(s) for receiving and measuring RSRP based on SSBs from the second cell, where the WTRU measures RSRP in DL subband of SBFD symbols. At 505, the WTRU may use the configured second TCI-state(s) (towards gNB2) for measuring CLI-RSSI in the configured CL-IM resources in UL subband of the SBFD symbols. At 506, for the measured CLI-RSSI lower than a first corresponding CLI-RSSI threshold, the WTRU may use the first set of RSRP threshold values for evaluating LTM events; for the measured CLI-RSSI higher than the first corresponding CLI-RSSI threshold, the WTRU may select a second RSRP threshold value for evaluating LTM events based on the second set of RSRP threshold values and the measured CLI-RSSI. For example, if the CLI-RSSI is higher than the first CLI-RSSI threshold and lower than a second CLI-RSSI threshold, the WTRU selects a first RSRP threshold from the second set of RSRP threshold values. If the CLI-RSSI is higher than the second CLI-RSSI threshold and lower than a third CLI-RSSI threshold, the WTRU selects a second RSRP threshold from the second set of RSRP threshold values.

At 507, the WTRU may use the selected RSRP threshold from the second set of RSRP threshold values for evaluating LTM events. For example, in Event LTM3: Beam of candidate cell becomes amount of offset selected from the 2nd set of threshold values better than beam of serving cell; in Event LTM4: Beam of candidate cell becomes better than an absolute threshold selected from the 2nd set of threshold values; in Event LTM5: Beam of serving cell becomes worse than absolute threshold1 AND Beam of candidate cell becomes better than an absolute threshold2 selected from the 2nd set of threshold values. At 508, the WTRU may determine based on the criteria for reporting of the (LTM) measurement events, to initiate a mobility report. For example, the report may include, but is not limited to include, any of the following: indication of the event (e.g., mobility event ID); indication of Scheduling Reference (SR) (e.g., for transmission of the MAC CE containing further results, possibly with the report size); and/or measurement result for the (mobility) event, etc.

CLI mitigation techniques are described herein. In a full duplex (e.g., SBFD) system, the potential effect of WTRU-to-WTRU and/or gNB-to-gNB CLI should be considered in cell switching and/or cell (re)selection procedures. The WTRU may need to mitigate the CLI in the serving cell and/or the candidate cell as part of the procedure.

In an example, if the CLI in the serving cell is affecting and/or interfering with the measurements from the candidate cell, the interference may cause inaccurate evaluation of the LTM events, resulting in WTRU staying in or selecting a suboptimal cell for switching that is not the best candidate cell. An example benefit for CLI mitigation during LTM cell switching procedure is that the WTRU may evaluate LTM events accurately and perform the cell switching to the best candidate cell. Also, this may provide benefits to avoid “ping-pong” effects due to frequent cell switching when identifying the CLI effects after cell switch.

In another example, if the CLI in the serving cell is affecting and/or interfering with the measurements from the candidate cell, the interference may cause inaccurate evaluation of the cell ranking values as part of cell (re)selection procedure, resulting in WTRU staying in or selecting a suboptimal cell that is not the best candidate cell. An example benefit for CLI mitigation during cell (re)selection procedure is that the WTRU may evaluate cell ranking values accurately and select the best candidate cell.

On the other hand, a WTRU may be configured and/or indicated that there may be no UL transmission in the symbols that overlap with SSB symbols. That is, the WTRUs operating based on SBFD operation may be configured to drop configured and/or indicated UL transmissions in (e.g., UL subband of) SBFD symbols that overlap with SSB transmissions. As such, when the WTRU is measuring SSBs from a first candidate cell, the WTRU may expect that no UL transmission may take place by the WTRUs in the first candidate cell. That is, the WTRU may determine that in case CLI is measured and/or detected in the symbols that overlap with SSB transmission from the first candidate cell, the CLI may be caused by the WTRUs in the serving cell or the WTRUs in another second neighbor cell.

Example methods may be based on measuring CLI in the symbols overlapping with SSB transmissions from a candidate cell is provided, where the CLI measurement enables the WTRU to determine the potential source of CLI. In the provided solution, in case the WTRU determines that the source of CLI is from WTRUs in its serving cell, the WTRU uses CLI mitigation techniques based on one or more new sets of offset and/or threshold values. In an example, the new threshold values may enable the WTRU for accurate evaluating of the events for LTM cell switching, conditional LTM cell switching, and/or CHO. In another example, the new offset values may enable the WTRU for accurate evaluating of the cell ranking values for cell (re)selection.

Example procedures for measuring CLI associated with SSBs from a candidate cell are described herein. Configurations may be used for measurements and evaluating CLI. In an example, a WTRU may receive one or more configuration information and/or indications on performing measurements and/or evaluating CLI along with performing one or more channel measurements in one or more candidate cells. For example, the WTRU may receive the configuration information (e.g., via SIB, RRC, MAC-CE, DCI, etc.). In an example, the WTRU may receive the configuration information for measuring the CLI and using the measured CLI for evaluating LTM events for the configured candidate cells. In another example, the WTRU may receive the configuration information for measuring the CLI and using the measured CLI for evaluating cell ranking values for the configured candidate cells. In an example, the WTRU may receive the CLI measurement and reporting configurations as part of candidate cell configuration (e.g., via RRC). In another example, the WTRU may receive the CLI measurement and reporting configurations separate from the received configurations on the candidate cells configuration (e.g., via RRC, MAC-CE, DCI, etc.).

In an example, the WTRU may receive, be configured, and/or indicated with one or more sets of time and frequency resources for measuring CLI (e.g., CLI-RSSI) (e.g., a new IE CLI-RSSI-MeasurementResourceSet) containing one or more sets of configuration information of CLI measurement resource(s) (e.g., CLI-RSSI-MeasurementResource), for example for L1 CLI-RSSI measurement. In an example, the CLI-RSSI measurement resource configurations may include CLI measurement resource ID, starting PRB index, number of PRBs, starting symbol of the CLI resource within a slot, number of symbols of the CLI resource within a slot, periodicity and slot offset for the CLI resource.

Time resources may be determined for CLI measurement. In an example, a WTRU may receive, be configured, and/or indicated to determine the time resources for measuring CLI with respect to and/or associated with the timing of the SSB symbols in the SSB burst. For example, the WTRU may be configured and/or indicated to determine the starting symbol and the time duration for CLI measurement resources based on the timing of the SSBs transmitted from a candidate cell. In an example, the WTRU may be configured and/or indicated to determine the starting symbol and/or time duration for CLI measurement resources based on the starting symbol and/or time duration of the SSBs, respectively, for example per SSB transmission occasion. In another example, the WTRU may be configured and/or indicated to determine the starting symbol and/or time duration for CLI measurement resources based on the starting symbol of the SSBs and/or time duration of SSB occasions, respectively, in addition to one or more configured and/or indicated offset values. For example, the configured and/or indicated offset values may be based on absolute time unit values (e.g., msec, usec) and/or based on time instances (e.g., symbols, slots). In another example, the WTRU may be explicitly configured and/or indicated with the time resources, starting symbol, and/or time duration for CLI measurement.

Frequency resources may be determined for CLI measurement. In an example, a WTRU may receive, be configured, and/or indicated to determine the frequency resources for measuring CLI with respect to and/or associated with the frequency resources of the SSB symbols in the SSB burst. For example, the WTRU may be configured and/or indicated to determine the starting RB and the RB length for CLI measurement resources based on the frequency of the SSBs transmitted from a candidate cell. In an example, the WTRU may be configured and/or indicated to determine the starting RB and/or RB length for CLI measurement resources based on the starting RB and/or RB length of the SSBs, for example per SSB transmission occasion, respectively. In another example, the WTRU may be configured and/or indicated to determine the starting RB and/or RB length for CLI measurement resources based on the starting RB and/or RB length of the SSBs in addition to one or more configured and/or indicated offset values. For example, the configured and/or indicated offset values may be based on number of RBs, PRBs, subbands, etc. In another example, the WTRU may be explicitly configured and/or indicated with the frequency resources, starting RB, and/or RB length for CLI measurement.

CLI threshold values may be used. In an example, a WTRU may be configured and/or indicated with one or more threshold corresponding to CLI measurements. The CLI threshold values may be associated with time duration, number of RBs, RB length, etc. used for CLI measurements.

Second TCI-states may be used, for example for CLI measurement. In an example, a WTRU may be configured and/or indicated with one or more second TCI-states. For example, the WTRU may be configured and/or indicated with the second TCI states based on one or more reference signals (RSs) (e.g., SSBs, CSI-RSs, etc.) from a candidate cell. In an example, the WTRU may activate and/or use the configured second TCI states for measuring one or more quality parameters (e.g., RSRP, RSRQ), etc.) based on one or more RSs (e.g., SSB, CSI-RS, etc.) received from the candidate cell. In another example, the WTRU may activate and/or use the configured second TCI states for measuring one or more CLI parameters (e.g., CLI-RSSI, SRS-RSRP, etc.) based on one or more RSs (e.g., SSB, CSI-RS, etc.) received from the candidate cell. In an example, the second TCI-states may be different from or the same as the TCI-states configured as part of the candidate cell configurations.

In an example CLI measurement procedure, a WTRU may perform CLI measurement based on one or more CLI measurement resources, where the WTRU may determine the source of CLI based on the measured CLI value. For example, the WTRU may determine, be configured, and/or indicated to use a second TCI-state to measure the CLI in the beam direction towards a candidate (e.g., non-serving) cell. In another example, the WTRU may determine, be configured, and/or indicated to measure the CLI in the same symbols as the SSB transmission in a candidate (e.g., non-serving) cell. For example, the WTRU may measure one or more first CLI measurements in an UL frequency resource (e.g., in UL PRBs, SBs, BWPs, etc.), for example in SBFD symbols. In another example, the WTRU may measure one or more second CLI measurements in an in a DL frequency resource (e.g., DL PRBs, SBs, BWPs, etc.), for example in SBFD symbols. In an example, the first and/or second CLI measurements may be based on CLI-RSSI or SRS-RSRP measurement. One or more of the following examples may apply. For example, CLI may be from WTRUs in the serving cell. Since UL transmission is not allowed in the candidate beam during SSB transmission, if the measured first CLI in UL frequency resources is higher than a threshold and higher than the second CLI measured in DL frequency resources, this may indicate that the first CLI may be caused by one or more WTRUs in the serving cell. In another example, CLI may be from WTRUs in other cells. If the measured first CLI in UL frequency resources is within a configured range from the second CLI measured in DL frequency resources, this may indicate that the first and second CLI may be caused by one or more WTRUs in the cells other than the serving and the candidate cell.

In an example, a WTRU that has measured and/or detected strong CLI from one or more WTRUs in the serving cell may determine to use a second set of thresholds and/or offset values for determining one or more events. For example, the WTRU may determine the CLI to be strong if the measured CLI is more than a configured threshold. In an example, the WTRU may determine that the measured strong CLI may affect one or more channel measurements from a candidate cell. For example, the WTRU may determine that the CLI may affect the RSRP measurement based on the candidate beam from a candidate cell, thus affecting the LTM events evaluations. In another example, the WTRU may determine that the CLI may affect the RSRP measurement based on a candidate cell, thus affecting the cell ranking evaluations and cell (re)selection procedures. For example, the WTRU may determine to use a first set of thresholds and/or offset values for evaluation of one or more events if the measured CLI is lower than the threshold. In another example, the WTRU may determine to use a second set of thresholds and/or offset values for evaluation of one or more events if the measured CLI is higher than the threshold.

Methods for selecting threshold and/or offset values based on measured CLI are disclosed herein. In an example, a WTRU may be configured and/or indicated with one or more sets of first threshold and/or offset values for evaluating one or more events. For example, the WTRU may use the first thresholds for evaluating LTM events. In another example, the WTRU may use the first offset values for evaluating the cell ranking values. In an example, the WTRU may use the first threshold and/or offset values for the cases without CLI and/or in cases where the measured CLI is lower than a corresponding threshold value. For example, the WTRU may use the first threshold and/or offset values for cases with non-SBFD operation.

In an example, the WTRU may be configured and/or indicated with one or more sets of second threshold and/or offset values for evaluating one or more events. In an example, the WTRU may use the second threshold and/or offset values for the case with SBFD operation, for example where the measured CLI may be higher than a corresponding threshold. In an example, the second threshold and/or offset values may include a list of values, from which the WTRU selects the threshold and/or offset value to be used based on one or more conditions. For example, the WTRU may select a threshold value from the set of second threshold and/or offset values based on the measured CLI.

In an example, the first and second sets of thresholds and/or offset values may correspond to one or more measured received power (e.g., RSRP), received signal quality (e.g., RSRQ), and/or received signal strength (e.g., RSSI).

In an example, a WTRU may determine, be configured, and/or indicated to determine and/or calculate the second threshold and/or offset values based on the first threshold and/or offset values. For example, the WTRU may calculate the second threshold and/or offset values based on the first threshold and/or offset values. In an example, the WTRU may determine, be configured, and/or indicated with one or more delta-offset values. As such, the WTRU may calculate the second threshold and/or offset values based on the first threshold and/or offset values and the configured delta offset values.

In an example, the WTRU may determine, be configured, and/or indicated with a list and/or table of second threshold and/or offset values, where the corresponding second threshold and/or offset values may be ordered in decreasing order. That is, the second threshold and/or offset values may be ordered, wherein the first threshold and/or offset value may have the highest value, the second threshold and/or offset value may be lower than the first threshold value, and so on, and the last threshold and/or offset value may have the lowest value. In another example, the WTRU may determine, be configured, and/or indicated with a delta offset value to be considered between the second threshold and/or offset values. That is, for example, the WTRU may be configured and/or indicated with the first threshold and/or offset value from the set of second threshold and/or offset values; the WTRU may determine the second threshold and/or offset based on the first threshold and/or offset value and the delta offset; the WTRU may determine the third threshold and/or offset value based on the second threshold and/or offset value and the delta offset. In another example, the WTRU may determine the first threshold and/or offset from the second threshold and/or offset values based on the corresponding threshold value from the first set of thresholds and/or offset value and the configured delta offset value.

In an example, a WTRU may determine and/or select one or more threshold and/or offset values from a first set or a second set of thresholds and/or offset values based on one or more conditions. For example, the WTRU may use the measured CLI value as a condition for determining the threshold and/or offset values to be used. In an example, the WTRU may determine the thresholds and/or offset values to be used for evaluating one or more LTM events, for example as part of LTM cell switching procedure. In an example, the WTRU may determine the thresholds and/or offset values to be used for evaluating one or more cell ranking values, for example as part of cell (re)selection procedure.

Example methods for selecting threshold and/or offset values are disclosed herein. In an example, the WTRU may determine, be configured, and/or indicated with at least one CLI threshold per configured and/or determined second threshold and/or offset values. As such, the WTRU may select the threshold and/or offset value from the second set of thresholds and/or offset values based on the measured CLI and the corresponding CLI threshold. One or more of the following examples may apply. In an example, in case the measured CLI is lower than a first CLI threshold value, the WTRU may use the threshold and/or offset values from the first set of thresholds and/or offset values. In another example, in case the measured CLI is higher than the first CLI threshold, the WTRU may select the threshold and/or offset value from the second set of thresholds and/or offset values, based on one or more of the following example cases: if the measured CLI is higher than the first CLI threshold and lower than a second CLI threshold, the WTRU may select a first threshold and/or offset value from the second set of thresholds and/or offset values; and/or if the measured CLI is higher than the second CLI threshold and lower than a third CLI threshold, the WTRU may select a second threshold value from the second set of thresholds and/or offset values.

Examples methods for use in CLI mitigation in cell switching operations are described below.

Example methods for candidate cells configuration for cell switching are disclosed herein. A WTRU may be connected to a serving cell, where the WTRU may determine, be configured, and/or indicated to perform transmission and/or reception based on a first activated TCI-state from the serving cell. In an example, the WTRU may be in RRC-Connected state.

The WTRU may receive, identify, be configured, and/or indicated to report (L1) (RRM) measurement reports, for example based on a candidate and/or candidate cell. The WTRU may receive indications (e.g., via MAC-CE, DCI, etc.) (e.g., from the serving cell) to change, configure, and initiate switching WTRU's serving cell to the candidate cell, for example based on the reported measurements. In an example, the WTRU may receive one or more configuration information on one or more candidate cells. For example, the WTRU may receive the configuration information via RRC signaling. In an example, the WTRU may receive configuration information for LTM cell switching. For example, the WTRU may receive configuration information for a (pre) configured maximum number of (e.g., eight) candidate cells. In an example, the WTRU may receive configuration information for each configured candidate cell, which may include any one or more of the following example information.

Example information may include Candidate cell ID. For example, the WTRU may receive configured candidate cell's index, identification, etc. Example information may include Candidate Cell PCI. For example, the WTRU may receive configured candidate cell's Physical Cell ID (PCI). Example information may include Candidate cell RRC configuration. For example, the WTRU may receive one or more RRC configurations corresponding to the candidate cell (e.g., via Itm-CandidateConfig). Example information may include Configurations on special modes of operation. In an example, the WTRU may receive configuration information on time and frequency resources where a special mode of operation is applied in the candidate cell. For example, the special mode of operation may be SBFD operation, cell DRX, cell DTX. For example, the WTRU may receive configuration information on time and frequency resources where the special mode of operation is applied. In an example, the WTRU may receive configurations (e.g., on the starting time, number of symbols, slots, frames, etc.) where the configurations regarding the special mode of operation may be applied. In another example, the WTRU may receive configurations on the starting RB, RB offsets, number of RBs, subbands, BWPs, direction of transmission in different RBs, guard bands, etc, where the configurations regarding the special mode of operation may be applied.

Example information may include TCI states. For example, the WTRU may receive one or more second TCI states for LTM cell switch to the corresponding candidate cell, where the configured TCI states may consist of UL, DL, and/or joint UL and DL TCI states. Example information may include CSI report configurations. For example, the WTRU may receive one or more CSI report configurations including the resources for channel measuring (e.g., RSRP, RSRQ, etc.), report type to be periodic, aperiodic, or semi-persistent, periodicity, slot offset, number of reported cells, number of reported RSs per cell, etc. (e.g., See Table 1). Example information may include Non-zero-power (NZP) CSI-RS resource(s) and/or resource set(s). For example, the WTRU may receive configuration information on one or more NZP CSI-RS resources and/or NZP CSI-RS resource sets associated with the corresponding candidate cell for LTM cell switch.

Example information may include SSB Config. For example, the WTRU may receive one or more configuration information on the SSB associated with the candidate cell based on which the WTRU may perform RRM measurements for the corresponding candidate cell. In an example, the configuration on the SSB may include the frequency of the SSBs, SSB burst's periodicity, time domain position of the transmitted SSBs in an SSB burst (e.g., via ssb-PositionsInBurst), SSBs' subcarrier spacing, SSB's secondary synchronization signal's (SS) energy per resource element (EPRE), etc.

Example methods for evaluating LTM events based on a candidate cell are disclosed herein. A WTRU may be configured and/or indicated with a first set of (e.g., activated) TCI-states for measuring one or more channel and/or interference parameters from a serving cell. The WTRU may be configured and/or indicated with a second set of (e.g., activated) TCI-states for measuring one or more channel and/or interference parameters from a neighbor, non-serving, and/or candidate cell.

In an example, (e.g., as part of LTM cell switching procedure) a WTRU may use the configured and/or indicated second set of TCI-states for measuring one or more quality parameters (e.g., RSRP, RSRQ, SINR, etc.). In an example, the WTRU may measure the quality parameters based on one or more RSs from the candidate cell (e.g., SSB, CSI-RS, etc.). For example, the WTRU operating in SBFD resources may use the DL subband for receiving and measuring the RSS from the candidate cell.

In an example, a WTRU may use one or more configured and/or indicated second TCI states for measuring CLI based on one or more configured CLI measurement resources from a candidate cell. In an example, the WTRU may determine, be configured, and/or indicated to measure CLI in the same symbols and/or at the same time as SSB transmission from the candidate cell. In another example, the WTRU may determine, be configured, and/or indicated to measure CLI in the one or more CLI measurement resources that are determined, configured, and/or indicated to be associated with at least an SSB transmission occasion from the candidate cell. In an example, the WTRU may perform the CLI measurement from the candidate cell as part of LTM cell switching procedure. For example, the WTRU may determine, be configured, and/or indicated to measure signal strength (e.g., CLI-RSSI, SRS-RSRP, etc.) from the candidate cell. In an example, the WTRU operating in SBFD resources may use the CLI measurement resources configured in the UL subband for receiving and measuring the CLI from the candidate cell. In another example, the WTRU operating in SBFD resources may use the CLI measurement resources configured in the DL subband for receiving and measuring the CLI from the candidate cell. In an example, the WTRU may determine that the measured CLI may be caused by the WTRUs in the serving cell, using example methods described herein.

In an example, in case a WTRU determines that measuring one or more quality parameters based on one or more RSs from a candidate cell may be impacted by CLI, the WTRU may determine the mode of operation based on one or more conditions. For example, the WTRU may receive, be configured, and/or indicated with one or more configuration information and/or indications on one or more modes of operation. The WTRU may be configured and/or indicated with one or more conditions, based on which the WTRU may choose the mode of operation. For example, the WTRU may receive the configuration information and/or indications (e.g., via SIB, RRC, MAC-CE, DCI, etc.). In an example, one or more of the following example modes of operation may apply: first mode of operation (e.g., skipping the SSBs affected by CLI); second mode of operation (e.g., applying the scaled set of threshold values); and/or third mode of operation (e.g., reporting the measured CLI).

According to a first Mode of Operation (e.g., skipping or deprioritizing SSBs affected by CLI), in an example, a WTRU may determine, be configured, and/or indicated to operate based on the first mode of operation if the number of SSBs that may be affected by CLI, for example in a configured time window, is lower than a configured maximum (MAX) number. In an example, the WTRU may receive one or more configuration information including a time window, where the time window may be the same as the time window configured for measuring, filtering, and/or evaluating the measured

RSRPs. In another example, the received configuration information may include the MAX number of measured SSBs that may be affected by CLI in the configured time window.

In an example, the WTRU may measure CLI in CLI measurement resources that may be associated with one or more received and/or measured SSBs. That is, for the SSBs and/or SSB beams that the WTRU measures RSRP, the WTRU may be configured with a time duration or frequency length for measuring the CLI. For example, the configured time and frequency resources may overlap with the time and frequency resources corresponding to the transmitted SSBs. In an example, the WTRU may measure the CLI in the indicated resources that may start one or more symbols before an SSB transmission occasion until one or more symbols after the SSB transmission occasion.

For example, the WTRU may be configured with the associated SSB indexes as part of the CLI measurement and/or reporting configurations. In another example, the WTRU may determine the association between SSB indexes and CLI measurement resources based on the overlapping of the CLI measurement resources with the transmitted SSB occasions. That is, for example, if the resources configured for CLI measurement fully overlaps or partially overlaps or is within a configured range from an SSB transmission occasion, the WTRU may consider the CLI measurement resources associated with the corresponding SSB index. For example, the configured range in time may be based on the time distance between CLI measurement time resources and the SSB transmission time occasion. For example, the time range may be configured based on absolute time units (e.g., msec, usec), or based on the number of time instances (e.g., symbols, slots, etc.). In another example, the configured range in frequency may be based on the frequency distance between CLI measurement frequency resources and the SSB transmission frequencies. For example, the frequency range may be configured based on absolute frequency units (e.g., kHz, MHZ, etc.), or based on the number of RBs, PRBs, etc.

In an example, the WTRU may be configured to measure the CLI based on aperiodic resources and/or measurements (e.g., based on configured slot offset and/or starting time). In another example, the WTRU may be configured to measure the CLI based on semi-persistent resources and/or measurements (e.g., based on configured starting symbol, time duration, end time, etc.) (e.g., based on SSB transmission occasions in the configured time window). In another example, the WTRU may be configured to measure the CLI based on periodic resources and/or measurements (e.g., based on configured starting symbol, time periodicity, etc.).

In an example, a WTRU may consider an SSB occasion as affected by the CLI if the measured CLI in the resources associated with the SSB occasion is higher than a determined, configured, and/or indicated CLI threshold. For example, the WTRU may receive, be configured, and/or indicated with one or more CLI threshold values. As such, the WTRU may compare the measured CLI associated with an SSB occasion with one or more of the configured threshold values. If the measured CLI is higher than a configured threshold, the WTRU may consider the associated SSB occasion to be affected by the CLI. In an example, the WTRU may determine, be configured, and/or indicated to measure the CLI associated with an SSB occasion based on CLI-RSSI, SRS-RSRP, etc. In another example, the WTRU may determine, be configured, and/or indicated to measure the CLI associated with an SSB occasion that may be in SBFD symbols based on UL subbands and/or DL subbands in the configured SBFD symbols.

In an example, in case the number of SSB occasions that are determined to be affected by the CLI, for example in the configured time window, is lower than the configured MAX number, the WTRU may determine to use the first mode of operation. As such, the WTRU may skip and/or discard the RSRP measurements based on the SSB occasions that are affected by the CLI in evaluating, calculating, and/or averaging the RSRP measurements in the configured time window. In another example, the WTRU may apply at least one bias parameter (e.g., a penalty parameter, a prioritization parameter, a weighting factor or coefficient affecting evaluation of the SSB measurement) based on (e.g., on top of, in combination with) the RSRP measurements based on the SSB occasions that are affected by the CLI (e.g., in determining, evaluating, calculating, and/or averaging the RSRP measurements in the configured time window).

According to a second mode of operation (e.g., applying scaled set of threshold values), in an example, a WTRU may determine, be configured, and/or indicated to operate based on the second mode of operation, based on one or more conditions. In an example, the WTRU may operate based on the second mode of operation if the number of SSBs that are affected by CLI, for example in the configured time window, is higher than the configured MAX number. In an example, the WTRU may receive one or more configuration information including a time window, where the time window may be the same as the time window configured for measuring, filtering, and/or evaluating the measured RSRPs. In another example, the received configuration information may include the MAX number of measured SSBs that may be affected by CLI in the configured time window.

In an example, a WTRU may determine and/or select one or more threshold values from a first set of threshold values or from a second set of threshold values based on one or more conditions. For example, the WTRU may use the measured CLI values as a condition for determining the threshold values to be used, as described herein. In an example, the WTRU may determine the thresholds to be used for evaluating one or more LTM events, for example as part of LTM cell switching procedure. In an example, the WTRU may determine and/or select the threshold value to be used from the first set of configured LTM-related threshold values or from the second set of configured LTM-related threshold values.

In an example, the WTRU may scale the threshold values based on the number of SSBs that are affected by the CLI in the configured time window. The WTRU may use one or more functions to determine the scaling for the threshold values. In an example, if M SSBs out of N SSBs are affected by the CLI, the WTRU may calculate a second threshold value based on a first threshold value, where second-threshold=first-threshold*(M/N). In another example, the WTRU may calculate and/or scale the threshold value based on the average measured CLI (e.g., within a configured time-window). The WTRU may determine and/or be configured with a reference CLI (e.g., REF-CLI) value. As such, the WTRU may calculate the second threshold value based on the first configured threshold value, the configured REF-CLI and the measured CLI. In an example, the WTRU may calculate: second-threshold=first-threshold*(REF-CLI/measured CLI).

In an example, the WTRU may use one or more functions to determine the scaling for the threshold values. For example, the function may scale the threshold values so that the higher is the CLI the smaller gets the threshold value.

In an example, the WTRU may select the threshold value for evaluating event LTM4, that is the beam (e.g., TCI-state) of candidate cell becomes better than the absolute RSRP threshold. The WTRU may measure CLI based on configured CLI measurement resources. In an example, the WTRU may be configured with one or more CLI threshold values. The WTRU may select the threshold value for evaluating the event LTM4 based on the measured CLI and the configured CLI threshold values. As such, the event LTM4 may be triggered if the measured RSRP based on the candidate second TCI-state corresponding to a candidate beam becomes more than the selected RSRP threshold value.

For example, in case the measured CLI is lower than a first CLI threshold value, the WTRU may select a first RSRP threshold value from the first set of threshold values. In another example, if the measured CLI is higher than the first CLI threshold and lower than a second CLI threshold, the WTRU may select a second RSRP threshold from the second set of RSRP threshold values, where the second RSRP threshold may be lower than the first RSRP threshold. In another example, if the measured CLI is higher than the second CLI threshold and lower than a third CLI threshold, the WTRU may select a third RSRP threshold from the second set of threshold values, where the third RSRP threshold may be lower than the second RSRP threshold.

An example benefit of using different threshold values in evaluation of LTM events is to compensate for potential degradation in measured quality parameters from the candidate cell (e.g., due to CLI from the WTRUs in the serving cell). That is, one or more quality parameters (e.g., RSRP, RSRQ, SINR, etc.) used for evaluating LTM events may be degraded and/or down estimated due to the CLI (e.g., from the WTRUs in the serving cell). As such, selecting the right threshold value that is scaled with the measured CLI could compensate for potential degradation in channel measurements.

In an example, in case the measured CLI is higher than the first CLI threshold, the WTRU may use the selected threshold from the second set of threshold values for evaluating one or more LTM events. One or more of the following example events may apply. According to example Event LTM3, for example, the WTRU may determine to trigger event LTM3 if the beam of the candidate cell becomes amount of offset and/or threshold value selected from the second set of threshold values better than beam of the serving cell. According to example Event LTM4, for example, the WTRU may determine to trigger event LTM3 if the beam of candidate cell becomes better than an absolute threshold selected from the second set of threshold values. According to example Event LTM5, for example, the WTRU may determine to trigger event LTM3 if the beam of serving cell becomes worse than absolute threshold1 AND Beam of candidate cell becomes better than an absolute threshold2 selected from the second set of threshold values.

In an example, the WTRU may determine to initiate a mobility report, for example based on the criteria for reporting of the (LTM) measurement events. In an example, the report may include indication of the event (mobility event ID), indication of SR (for transmission of the MAC CE containing further results, possibly with the report size), measurement result for the (mobility) event, etc.

According to a third mode of operation (e.g., Reporting the Measured CLI), in an example, a WTRU may determine, be configured, and/or indicated to operate based on the third mode of operation. The third mode of operation may be based on reporting the measured CLI, where the CLI may be measured in associated with one or more SSBs received from a candidate cell. In an example, the WTRU may be configured with one or more report configuration for reporting the measured CLI, the report configurations may include the time and frequency grants for sending the report, the type of the CLI report including periodic, semi-persistent, and/or aperiodic, etc.

In an example, the WTRU may determine, be configured, and/or indicated to report the measured CLI if the WTRU determines that the source of CLI is from a candidate cell, as described herein (e.g., on determining the source of CLI). In another example, the WTRU may determine, be configured, and/or indicated to report the measured CLI if the WTRU determines that the source of CLI is from the serving cell, as described herein (e.g., on determining the source of CLI). In another example, the WTRU may determine, be configured, and/or indicated to report the measured CLI if the measured CLI is higher than a configured MAX threshold value.

In an example, the WTRU may report information. Example information that may be included in the reports may include any one or more of the following example information. Example information may include measured CLI. For example, the WTRU may report the measured CLI (e.g. CLI-RSSI, SRS-RSRP, etc.). Example information may include TCI-state information used for measuring the CLI. For example, the WTRU may report the TCI-state that the WTRU used for measuring the reported CLI. In an example, the TCI-state may be associated with a beam direction towards the candidate cell. Example information may include the associated SSB index. For example, the WTRU may report the SSB index, for which the RSRP measurement may be affected by the reported CLI. In an example, the reported SSB index may be from a candidate cell. Example information may include candidate cell information. For example, the WTRU may report the candidate cell (e.g., corresponding cell ID and/or PCI, for which the RSRP measurement may be affected by the reported CLI). Example information may include information indicating time instances where CLI was detected and/or measured. For example, the WTRU may report the time instances (e.g., symbols, slots, etc.) including the starting symbol, the time duration, and/or the end symbol during which the reported CLI was measured. In another example, the WTRU may indicate the time instances during which the CLI was detected to be higher than one or more threshold values. Example information may include an indication whether CLI was measured in SBFD or non-SBFD symbols. For example, the WTRU may indicate whether the reported CLI was measured in SBFD or non-SBFD symbols. . . . Example information may include an indication whether CLI was measured in symbols overlapping with SSBs. For example, the WTRU may indicate that the reported CLI was measured in symbols that were fully overlapping, partially overlapping, or non-overlapping with SSB symbols. In an example, the WTRU may indicate the overlapping with SSB symbols based on SSBs from the candidate cell.

Methods for CLI mitigation in cell (re)selection operation are disclosed herein. Examples of candidate cells configuration information for cell (re)selection are disclosed herein. A WTRU may be in RRC-Idle or RRC-Inactive state, where the WTRU may calculate and/or evaluate cell ranking values for the serving cell and one or more neighbor target cells, for example as part of cell (re)selection procedure.

In an example, the WTRU may receive and/or detect one or more SSBs from its serving cell. For example, the serving cell may be the last cell that the WTRU was connected to. In another example, the WTRU may receive and/or detect one or more SSBs from a neighbor candidate cell. The WTRU may receive a physical broadcast channel (PBCH). The PBCH may carry system information. The PBCH may include or carry a master information block (MIB). The term MIB may be used to represent the content, information, payload, and/or bits carried by the PBCH. PBCH and MIB may be used interchangeably herein. The PBCH may be part of an SSB. The SSB may have an SSB index. The WTRU may use the configuration information received via MIB to decode, receive, and/or detect one or more SIBs. The WTRU may receive one or more configuration information regarding the serving cell and one or more candidate cells based on the decoded MIB and SIBs from serving cell and candidate cells, respectively. In an example, the SIBs received from the serving cell may include one or more configuration information on one or more candidate cells. One or more of the following example information regarding the full-duplex (FD) operation in the serving cell and/or candidate cells may be included in the corresponding configuration information.

Example configuration information may include SBFD mode. For example, the WTRU may determine if the detected cell supports SBFD operation or that the detected cell operates in a non-SBFD mode of operation. Example configuration information may include SBFD time and frequency resources. For example, the WTRU may receive configuration information on time and frequency resources were SBFD may be applied. For example, the WTRU may receive the starting symbol, time duration, starting PRB, RB length, guard bands, UL subbands, DL subbands, direction of transmission. Example configuration information may include CLI measurement resources: For example, the WTRU may receive configuration information on one or more CLI measurement resources, including the starting symbol, time duration, starting PRB, RB length, CLI measurement configuration ID, reference signals for CLI measurement (e.g., SRS for SRS-RSRP measurement). Example configuration information may include first and second sets of thresholds, offset values, compensations, and/or scaling parameters.

Examples methods for evaluating cell ranking of a candidate cell are disclosed herein. A WTRU may determine, select, and/or use a first set of TCI-states for measuring one or more channel and/or interference parameters from a serving cell. The WTRU may determine, select, and/or use a second set of TCI-states for measuring one or more channel and/or interference parameters from a neighbor, non-serving, and/or candidate cell. In an example, (e.g., as part of cell (re)selection procedure) a WTRU may use the determined second set of TCI-states for measuring one or more quality parameters (e.g., RSRP, RSRQ, SINR, etc.). In an example, the WTRU may measure the quality parameters based on one or more SSBs from the candidate cell. For example, the WTRU operating in SBFD resources may use the DL subband for receiving and measuring the SSBs from the candidate cell.

In an example, a WTRU may use one or more determined second TCI states for measuring CLI based on one or more CLI measurement resources from a candidate cell. In an example, the WTRU may determine, be (pre) configured, and/or (pre) indicated to measure CLI in the same symbols and/or at the same time as SSB transmission from the candidate cell. In an example, the WTRU may perform the CLI measurement from the candidate cell as part of cell (re)selection procedure. For example, the WTRU may measure signal strength (e.g., CLI-RSSI, SRS-RSRP, etc.) from the candidate cell. In an example, the WTRU operating in SBFD resources may use the CLI measurement resources in the UL subband for receiving and measuring the CLI from the candidate cell. In another example, the WTRU operating in SBFD resources may use the CLI measurement resources in the DL subband for receiving and measuring the CLI from the candidate cell. In an example, the WTRU may determine that the measured CLI may be caused by the WTRUs in the serving cell, as described herein.

In an example, in case a WTRU determines that measuring one or more quality parameters based on one or more SSBs from a candidate cell may be impacted by CLI, the WTRU may determine the mode of operation based on one or more conditions. For example, the WTRU may be configured and/or indicated with one or more configuration information and/or indications on one or more modes of operation. The WTRU may be configured and/or indicated with one or more conditions, based on which the WTRU may choose the mode of operation. For example, the WTRU may receive the configuration information and/or indications, for example via SIB, for example detected from the serving cell and/or the candidate cell. In an example, one or more of the following example modes of operation may apply first mode of operation (e.g., skipping the SSBs affected by CLI); and/or second mode of operation (e.g., applying the scaled set of threshold values).

According to the first mode of operation (e.g., skipping or deprioritizing the SSBs affected by CLI), in an example, a WTRU may determine, be configured, and/or indicated to operate based on the first mode of operation if the number of SSBs that may be affected by CLI, for example in a configured time window, is lower than a configured MAX number. In an example, the WTRU may determine and/or be (pre) configured with a time window, where the time window may be the same as the time window used for measuring, filtering, and/or evaluating the measured RSRPs. In another example, the WTRU may determine, be (pre) configured, or receive configuration information on the MAX number of measured SSBs that may be affected by CLI in the used time window.

In an example, the WTRU may measure CLI in CLI measurement resources that may be associated with one or more received and/or measured SSBs. That is, for the SSBs and/or SSB beams that the WTRU measures RSRP, the WTRU may use the configured time and frequency resources for measuring the CLI. For example, the configured time and frequency resources may overlap with the time and frequency resources corresponding to the transmitted SSBs. In an example, the WTRU may measure the CLI in the indicated resources that may start one or more symbols before an SSB transmission occasion until one or more symbols after the SSB transmission occasion.

For example, the WTRU may be configured with the associated SSB indexes as part of the CLI measurement and/or reporting configurations. In another example, the WTRU may determine the association between SSB indexes and CLI measurement resources based on the overlapping of the CLI measurement resources with the transmitted SSB occasions. For example, if the resources configured for CLI measurement fully overlaps or partially overlaps or is within a configured range from an SSB transmission occasion, the WTRU may consider the CLI measurement resources associated with the corresponding SSB index. For example, the configured range in time may be based on the time distance between

CLI measurement time resources and the SSB transmission time occasion. For example, the time range may be configured based on absolute time units (e.g., msec, usec), or based on the number of time instances (e.g., symbols, slots, etc.). In another example, the configured range in frequency may be based on the frequency distance between CLI measurement frequency resources and the SSB transmission frequencies. For example, the frequency range may be configured based on absolute frequency units (e.g., kHz, MHZ, etc.), or based on the number of RBs, PRBs, etc.

In an example, a WTRU may consider an SSB occasion as affected by the CLI if the measured CLI in the resources associated with the SSB occasion is higher than a determined, configured, and/or indicated CLI threshold. For example, the WTRU may receive, be configured, and/or indicated with one or more CLI threshold values. As such, the WTRU may compare the measured CLI associated with an SSB occasion with one or more of the configured threshold values. If the measured CLI is higher than a configured threshold, the WTRU may consider the associated SSB occasion to be affected by the CLI. In an example, the WTRU may determine, be configured, and/or indicated to measure the CLI associated with an SSB occasion based on CLI-RSSI, SRS-RSRP, etc. In another example, the WTRU may determine, be configured, and/or indicated to measure the CLI associated with an SSB occasion that may be in SBFD symbols based on UL subbands and/or DL subbands in the configured SBFD symbols.

In an example, in case the number of SSB occasions that are determined to be affected by the CLI, for example in the configured time window, is lower than the configured MAX number, the WTRU may determine to use the first mode of operation. As such, the WTRU may skip and/or discard the RSRP measurements based on the SSB occasions that are affected by the CLI in evaluating, calculating, and/or averaging the RSRP measurements in the configured time window. In another example, the WTRU may apply at least one bias parameter (e.g., a penalty parameter, a prioritization parameter, a weighting factor or coefficient affecting evaluation of the SSB measurement) based on (e.g., on top of, in combination with) the RSRP measurements based on the SSB occasions that are affected by the CLI (e.g., in determining, evaluating, calculating, and/or averaging the RSRP measurements in the configured time window).

According to a second mode of operation (e.g., applying the scaled set of threshold values), in an example, a WTRU may determine, be configured, and/or indicated to operate based on the second mode of operation, based on one or more conditions. In an example, the WTRU may operate based on the second mode of operation if the number of SSBs that are affected by CLI, for example in the configured time window, is higher than the configured MAX number. In an example, the WTRU may determine and/or be (pre) configured with a time window, where the time window may be the same as the time window used for measuring, filtering, and/or evaluating the measured RSRPs. In another example, the WTRU may receive or be (pre) configured with a MAX number of measured SSBs that may be affected by CLI in the configured time window.

In an example, a WTRU may determine and/or select one or more offset values from a first set of offset values or from a second set of offset values based on one or more conditions. For example, the WTRU may use the measured CLI values as a condition for determining the offset values to be used, as described herein. In an example, the WTRU may determine the offset to be used for evaluating cell ranking values for one or more candidate cells, for example as part of cell (re)selection procedure.

In an example, the WTRU may scale the offset values based on the number of SSBs that are affected by the CLI in the configured time window. In another example, the WTRU may calculate and/or scale the offset value based on the average measured CLI (e.g., within the configured time-window). The WTRU may use one or more functions to determine the scaling for the offset values. In an example, the function may scale the offset values so that the higher is the CLI the larger gets the offset value.

In an example, the WTRU may be configured with one or more CLI threshold values. The WTRU may select the offset value for evaluating the cell ranking value based on the measured CLI and the configured CLI threshold values. In an example, the WTRU may use the received configuration information on the first or second sets of thresholds and/or offset values to be used for selecting the offset value to be used for evaluating the cell ranking value for the candidate cells. In an example, the WTRU may use the first set of thresholds and/or offset values in case the WTRU operates based on a first mode of operation (e.g., non-SBFD operation). In another example, the WTRU may use the first set of thresholds and/or offset values in case the WTRU operates based on a second mode of operation (e.g., SBFD operation), based on one or more conditions. For example, the WTRU may use the first set if the measured CLI is lower than a corresponding CLI threshold. In another example, the WTRU may use the second set of thresholds and/or offset values in case the WTRU operates based on a second mode of operation (e.g., SBFD operation), based on one or more conditions. For example, the WTRU may use the second set if the measured CLI is higher than a corresponding CLI threshold.

For example, the WTRU may use the following equation for determining cell ranking value for a neighbor candidate cell, i.e., Rₙ=Q_{meas,n}+Q_{offset}-Q_{offsettemp}+Q_{offset}-CLI. The value of Q_{offset}-CLI may correspond to the selected offset value, for example from the second set of offset values.

In an example, in case the measured CLI is lower than a first CLI threshold value, the WTRU may select a first Q_{offset}-CLI offset value from the first set of offset values. In another example, if the measured CLI is higher than the first CLI threshold and lower than a second CLI threshold, the WTRU may select a second Q_{offset}-CLI offset from the second set of offset values, where the first Q_{offset}-CLI offset may be lower than the second Q_{offset}-CLI offset. In another example, if the measured CLI is higher than the second CLI threshold and lower than a third CLI threshold, the WTRU may select a third Q_{offset}-CLI offset from the second set of threshold values, where the second Q_{offset}-CLI offset may be lower than the third Q_{offset}-CLI offset.

An example benefit of using the Q_{offset}-CLI offset value in evaluation of cell ranking is to compensate for potential degradation in measured quality parameters from the candidate cell (e.g., due to CLI from the WTRUs in the serving cell). That is, one or more quality parameters (e.g., RSRP, RSRQ, SINR, etc.) used for evaluating Q_{meas,n} in cell ranking value may be degraded and/or down estimated due to the CLI (e.g., from the WTRUs in the serving cell). As such, by selecting the right Q_{offset}-CLI that is scaled with the measured CLI could compensate for potential degradation in Q_{meas,n}.

Examples methods for cell ranking are disclosed herein. In an example, based on the evaluated cell ranking values, the WTRU may determine to select the candidate cell with the highest evaluated cell ranking. The WTRU may send PRACH to the selected candidate cell (e.g., to connect to the cell). After connecting to the candidate cell, the WTRU may send a report to indicate one or more information regarding the measured CLI. The report may include one or more example parameters, such as the measured CLI, the TCI-state used for measuring the CLI, the associated SSB index, the candidate cell ID, the time instances where CLI was detected and/or measured, whether CLI was measured in SBFD or non-SBFD symbols, whether CLI was measured in symbols overlapping with SSBs, as described herein.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A wireless transmit/receive unit (WTRU) comprising:
a transceiver; and
a processor, wherein the transceiver and the processor are configured to:
communicate, with a first base station in a serving cell, using downlink subbands of a first frequency band and an uplink subband of the first frequency band in full duplex slots, wherein the downlink subbands and the uplink subband are non-overlapping;
measure a signal strength of a signal received on the uplink subband in a first full duplex slot;
select a set of reference signal received power (RSRP) threshold values from among a plurality of sets of RSRP threshold values by comparing the measured signal strength to at least one threshold;
evaluate one or more mobility measurement events using the selected set of RSRP threshold values to trigger cell switching, cell selection, or cell reselection; and
perform the triggered cell switching, cell selection, or cell reselection.

2. The WTRU of claim 1, wherein the transceiver and the processor are further configured to:
communicate, with the first base station in the serving cell, using the first frequency band in downlink slots, uplink slots, and flexible slots.

3. The WTRU of claim 1, wherein the first frequency band is a time division duplex (TDD) frequency band that permits subband non-overlapping full duplex (SBFD) operation in the full duplex slots.

4. The WTRU of claim 1, wherein the signal received on the uplink subband in the first full duplex slot is cross-link interference from a second WTRU.

5. The WTRU of claim 1, wherein the one or more mobility measurement events are layer 1/layer 2 triggered mobility (LTM) measurement events and include: a beam of the serving cell becoming worse than a first absolute threshold; a beam of a candidate cell becoming an amount of offset better than the beam of the serving cell; the beam of the candidate cell becoming better than a second absolute threshold; and the beam of the serving cell becoming worse than the first absolute threshold and the beam of the candidate cell becoming better than the second absolute threshold.

6. The WTRU of claim 1, wherein the transceiver and the processor are further configured to:
measure a signal strength of a synchronization signal block (SSB) signal received, from a second base station in a second cell, in one of the downlink subbands of the first frequency band, wherein the mobility measurement events are evaluated using the selected set of RSRP threshold values and the measured signal strength of the SSB signal.

7. The WTRU of claim 6, wherein the SSB signal and the signal received on the uplink subband are received in a same symbol of the first full duplex slot.

8. The WTRU of claim 1, wherein the transceiver and the processor are further configured to:
receive, from the first base station, radio resource control (RRC) configuration information for measuring synchronization signal block (SSB) signals in the downlink subbands of the first frequency band in the full duplex slots and reporting channel station information (CSI) based on performed measurements.

9. The WTRU of claim 1, wherein the transceiver and the processor are further configured to:
send, to the first base station, a mobility report based on criteria for reporting mobility measurement events.

10. The WTRU of claim 1, wherein the at least one threshold includes a first threshold, a second threshold, and a third threshold that are preconfigured, and wherein:
the selected set of RSRP threshold values is a first set of RSRP threshold values when the measured signal strength is less than the first threshold;
the selected set of RSRP threshold values is a second set of RSRP threshold values when the measured signal strength is greater than the first threshold and less than the second threshold; and
the selected set of RSRP threshold values is a third set of RSRP threshold values when the measured signal strength is greater than the first threshold and greater than the second threshold.

11. A method performed by a wireless transmit/receive unit (WTRU), the method comprising:
communicating, with a first base station in a serving cell, using downlink subbands of a first frequency band and an uplink subband of the first frequency band in full duplex slots, wherein the downlink subbands and the uplink subband are non-overlapping;
measuring a signal strength of a signal received on the uplink subband in a first full duplex slot;
selecting a set of reference signal received power (RSRP) threshold values from among a plurality of sets of RSRP threshold values by comparing the measured signal strength to at least one threshold;
evaluating one or more mobility measurement events using the selected set of RSRP threshold values to trigger cell switching, cell selection, or cell reselection; and
performing the triggered cell switching, cell selection, or cell reselection.

12. The method of claim 11, further comprising:
communicating, with the first base station in the serving cell, using the first frequency band in downlink slots, uplink slots, and flexible slots.

13. The method of claim 11, wherein the first frequency band is a time division duplex (TDD) frequency band that permits subband non-overlapping full duplex (SBFD) operation in the full duplex slots.

14. The method of claim 11, wherein the signal received on the uplink subband in the first full duplex slot is cross-link interference from a second WTRU.

15. The method of claim 11, wherein the one or more mobility measurement events are layer 1/layer 2 triggered mobility (LTM) measurement events and include: a beam of the serving cell becoming worse than a first absolute threshold;
a beam of a candidate cell becoming an amount of offset better than the beam of the serving cell; the beam of the candidate cell becoming better than a second absolute threshold; and the beam of the serving cell becoming worse than the first absolute threshold and the beam of the candidate cell becoming better than the second absolute threshold.

16. The method of claim 11, further comprising:
measuring a signal strength of a synchronization signal block (SSB) signal received, from a second base station in a second cell, in one of the downlink subbands of the first frequency band, wherein the mobility measurement events are evaluated using the selected set of RSRP threshold values and the measured signal strength of the SSB signal.

17. The method of claim 16, wherein the SSB signal and the signal received on the uplink subband are received in a same symbol of the first full duplex slot.

18. The method of claim 11, further comprising:
receiving, from the first base station, radio resource control (RRC) configuration information for measuring synchronization signal block (SSB) signals in the downlink subbands of the first frequency band in the full duplex slots and reporting channel station information (CSI) based on performed measurements.

19. The method of claim 11, further comprising:
sending, to the first base station, a mobility report based on criteria for reporting mobility measurement events.

20. The method of claim 11, wherein the at least one threshold includes a first threshold, a second threshold, and a third threshold that are preconfigured, and wherein:
the selected set of RSRP threshold values is a first set of RSRP threshold values when the measured signal strength is less than the first threshold;
the selected set of RSRP threshold values is a second set of RSRP threshold values when the measured signal strength is greater than the first threshold and less than the second threshold; and
the selected set of RSRP threshold values is a third set of RSRP threshold values when the measured signal strength is greater than the first threshold and greater than the second threshold.
